(19) United States
(12) Patent Application Publication
(10) Pub. No.: US 2010/0026771 A1
(43) Pub. Date: Feb. 4, 2010

(54) INKJET RECORDING METHOD, INKJET RECORDING SYSTEM, AND PRINTED MATERIAL

(75) Inventor: Kyohei MOCHIZUKI, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/511,477

(22) Filed: Jul. 29, 2009

(30) Foreign Application Priority Data
Jul. 30, 2008 (JP) 2008-196767

(51) Int. Cl. B41J 2/01

(52) U.S. Cl. 347/102

(57) ABSTRACT

An inkjet recording method is provided that includes a step of discharging onto a recording medium an ink composition containing a vinyl ether compound, an oxirane compound and/or oxetane compound, a cationic photopolymerization initiator, and a colorant, and a step of curing the discharged ink composition by irradiation with UV rays by UV irradiation means having an aperture type hot cathode fluorescent tube having a getter in the interior thereof. There are also provided an inkjet recording system that includes recording medium transport means, an inkjet head for discharging an ink composition containing a vinyl ether compound, an oxirane compound and/or oxetane compound, a cationic photopolymerization initiator, and a colorant to thus form an image on a recording medium, and UV irradiation means for curing the ink composition discharged onto the recording medium by irradiation with UV rays, the UV irradiation means having as a UV light source an aperture type hot cathode fluorescent tube having a getter in the interior thereof, a printed material obtained by the inkjet recording method, and a printed material obtained using the inkjet recording system.

### BACKGROUND OF THE INVENTION

1. Field of the Invention

The present invention relates to an inkjet recording method, an inkjet recording system, and a printed material.

2. Description of the Related Art

An inkjet system in which an image is formed by discharging onto a recording medium using an inkjet head an ink that is cured by energy such as UV rays or an electron beam and curing the ink by irradiation with energy has the characteristics that it is environmentally friendly, recording is possible on a variety of recording media at high speed, and a high definition image resistant to spreading can be obtained.

In particular, a system employing a UV curing ink has been developed from the viewpoint of ease of handing of a light source, compact size, etc. By taking advantage in particular of its high speed fixation, the so-called single pass inkjet system has been devised in which a web-form recording medium that can be transported at high speed is disposed so as to face a fixed head that has a width enabling the whole width of the recording medium to be recorded, and recording is completed by passing the recording medium beneath the head only once.

When carrying out color printing using this single pass inkjet system, fixed heads of a number corresponding to the number of colors are arranged in the transport direction of the recording medium, and in this case in order to prevent different color inks from being mixed, JP-A-2004-314586 (JP-A denotes a Japanese patent application publication) discloses a system in which light irradiation means is disposed downstream of each color head.

Furthermore, JP-A-2004-237602 discloses an inkjet system employing an inexpensive cold cathode fluorescent tube or hot cathode fluorescent tube with a cationic UV curing ink.

### BRIEF SUMMARY OF THE INVENTION

In a conventional inkjet recording system employing a high-pressure mercury lamp or a metal halide lamp as an actinic radiation generating light source, there are the problems of large size and high cost of the overall inkjet recording system due to the mercury lamp or metal halide lamp having a considerable size and being expensive.

On the other hand, when a small-size light source such as a hot cathode tube, a cold cathode tube, an LED, or a laser diode is used as an actinic radiation generating light source, there are the problems that, since the illumination intensity is low and irradiation can only be carried out with UV rays having a single peak wavelength, it is difficult to cure an ink having low sensitivity at the peak wavelength of light emitted by the light source, and the image quality of an image formed is poor.

Furthermore, with regard to UV curing inks, when a cationic polymerization type ink composition comprising a relatively high curing sensitivity cationic polymerization initiator and a cationically polymerizable monomer is cured with low illumination intensity, there is the problem of environmental temperature dependence, that is, the film strength depends on environmental temperature; when the environmental temperature is high a high film strength is exhibited, and when the environmental temperature is low the film strength is decreased.

While taking into consideration the above-mentioned problems, it is an object of the present invention to provide an inkjet recording method and inkjet recording system that can form high quality images over a long period of time using a small-size, inexpensive UV irradiation device and can form printed materials having high film strength irrespective of environmental temperature, and a printed material obtained by using the inkjet recording method and/or inkjet recording system.

The problems to be solved by the present invention have been solved by means described in <1>, <9>, <10> and <18> below. They are described below together with <2> to <8> and <11> to <17>, which are preferred embodiments.

<1>. An inkjet recording method comprising: a step of discharging onto a recording medium an ink composition comprising a vinyl ether compound, an oxirane compound and/or oxetane compound, a cationic photopolymerization initiator, and a colorant; and a step of curing the discharged ink composition by irradiation with UV rays by UV irradiation means comprising an aperture type hot cathode fluorescent tube having a getter in the interior thereof,

<2>. The inkjet recording method according to <1>, wherein the vinyl ether compound in the ink composition has a content of 1 to 84 wt %,

<3>. The inkjet recording method according to <1>, wherein the ratio by weight of the vinyl ether compound to the total amount of the oxirane compound and oxetane compound in the ink composition is vinyl ether compound: oxirane compound and oxetane compound=1:99 to 90:10,

<4>. The inkjet recording method according to <1>, wherein the ink composition has a viscosity at 25° C. of 5 to 50 mPa·s,

<5>. The inkjet recording method according to <1>, wherein the ink composition comprises an oxirane compound and an oxetane compound,

<6>. The inkjet recording method according to <1>, wherein the vinyl ether compound is a compound represented by Formula (1),

R¹³—R¹⁴—(R¹³)p (1 )

(in Formula (1), R¹³ is selected from a vinyl ether group, a vinyl ether skeleton-containing group, an alkoxy group, a hydroxy group-substituted group, and a hydroxy group, at least one thereof being a vinyl ether group or a vinyl ether skeleton-containing group, R¹⁴ is a (p+1)-valent group having a substituted or unsubstituted cyclic skeleton, and p is a positive integer including 0),

<7>. The inkjet recording method according to <1>, wherein the vinyl ether compound is at least one compound selected from the group consisting of VE-A to VE-E,

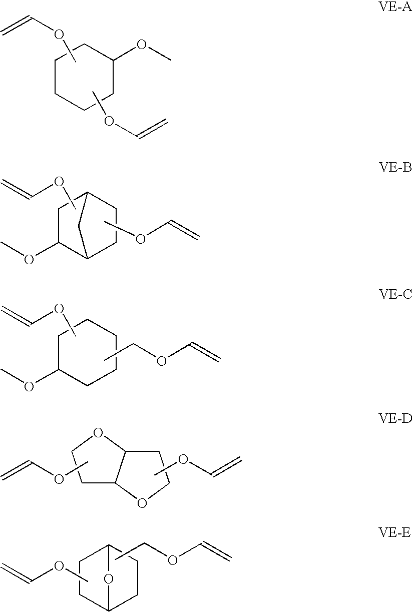

<8>. The inkjet recording method according to <1>, wherein the hot cathode fluorescent tube further comprises a cooling mechanism,

<9>. A printed material obtained by the inkjet recording method according to <1>,

<10>. An inkjet recording system comprising: recording medium transport means; an inkjet head for discharging an ink composition comprising a vinyl ether compound, an oxirane compound and/or oxetane compound, a cationic photopolymerization initiator, and a colorant to thus form an image on a recording medium; and UV irradiation means for curing the ink composition discharged onto the recording medium by irradiation with UV rays; the UV irradiation means comprising as a UV light source an aperture type hot cathode fluorescent tube having a getter in the interior thereof,

<11>. The inkjet recording system according to <10>, wherein the vinyl ether compound in the ink composition has a content of 1 to 84 wt %,

<12>. The inkjet recording system according to <10>, wherein the ratio by weight of the vinyl ether compound to the total amount of the oxirane compound and oxetane compound in the ink composition is vinyl ether compound: oxirane compound and oxetane compound=1:99 to 90:10,

<13>. The inkjet recording system according to <10>, wherein the ink composition has a viscosity at 25° C. of 5 to 50 mPa·s,

<14>. The inkjet recording system according to <10>, wherein the ink composition comprises an oxirane compound and an oxetane compound,

<15>. The inkjet recording system according to <10>, wherein the vinyl ether compound is a compound represented by Formula (1),

R¹³—R¹⁴—(R¹³)p (1 )

(in Formula (1), R¹³ is selected from a vinyl ether group, a vinyl ether skeleton-containing group, an alkoxy group, a hydroxy group-substituted group, and a hydroxy group, at least one thereof being a vinyl ether group or a vinyl ether skeleton-containing group, R¹⁴ is a (p+1)-valent group having a substituted or unsubstituted cyclic skeleton, and p is a positive integer including 0),

<16>. The inkjet recording system according to <10>, wherein the vinyl ether compound is at least one compound selected from the group consisting of VE-A to VE-E,

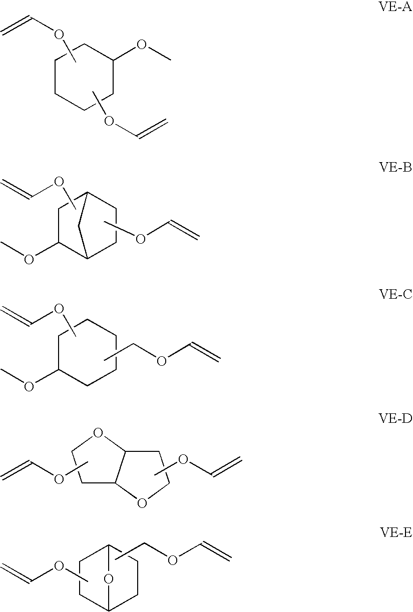

<17>. The inkjet recording system according to <10>, wherein the hot cathode fluorescent tube further comprises a cooling mechanism,

<18>. A printed material obtained using the inkjet recording system according to <10>.

### BRIEF DESCRIPTION OF DRAWINGS

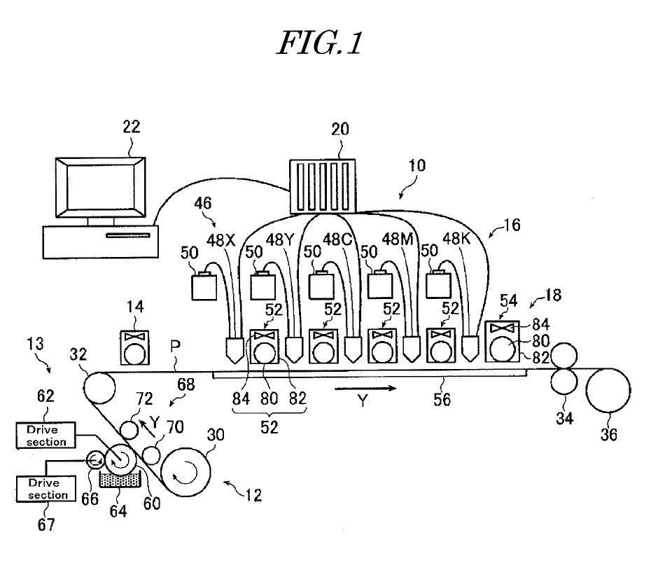

(FIG. 1) A front view showing the schematic configuration of one example of the inkjet recording system related to the present invention.

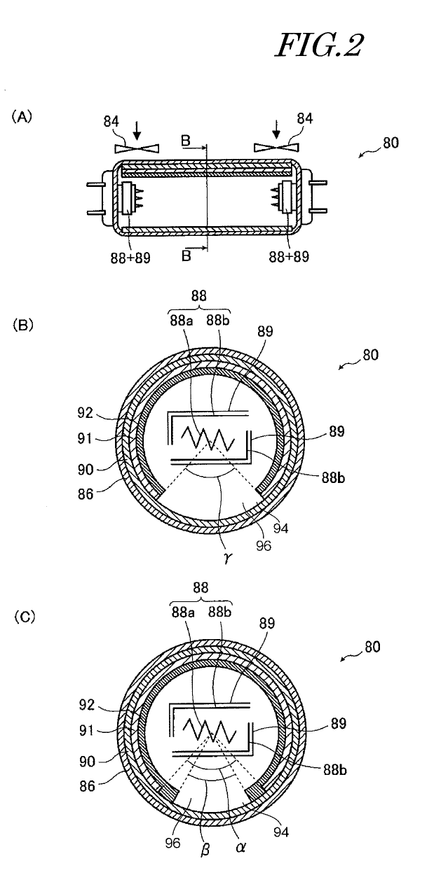

(FIG. 2) Views showing the schematic configuration of one example of a light irradiation device (UV irradiation unit) used in the inkjet recording system related to the present invention; (A) is a longitudinal sectional view showing the schematic configuration of one example of a fluorescent lamp, and (B) and (C) are sectional views along line B-B of the fluorescent lamp shown in (A).

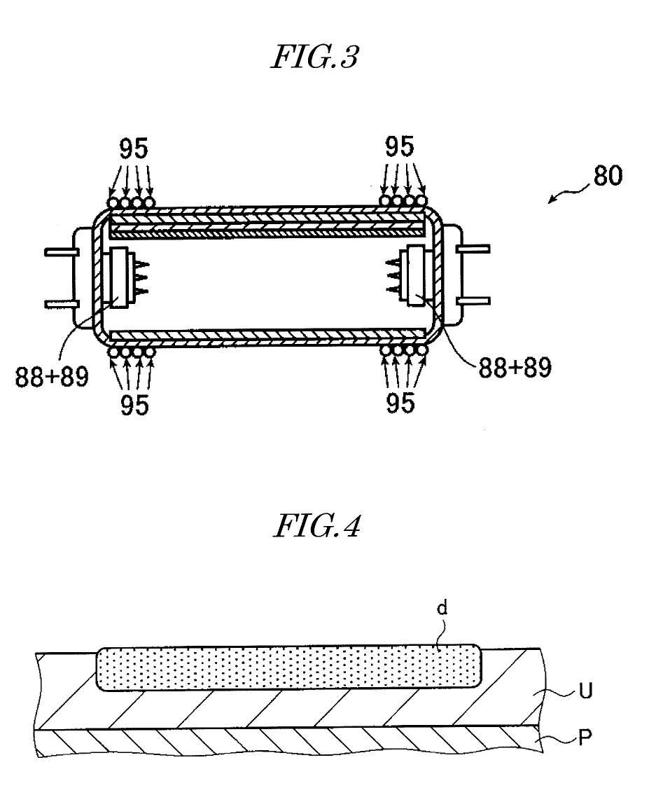

(FIG. 3) A view showing the schematic configuration of another example of a light irradiation device used in the inkjet recording system related to the present invention, and a longitudinal sectional view of a fluorescent lamp.

(FIG. 4) A schematic sectional view showing one example of a recording medium in which an ink composition is fired onto a semi-cured undercoat liquid.

(FIG. 5) (A) and (B) are schematic sectional views showing one example of a recording medium in which an ink composition is fired onto an uncured undercoat liquid, and (C) is a schematic sectional view showing one example of a recording medium in which an ink composition is fired onto a completely cured undercoat liquid.

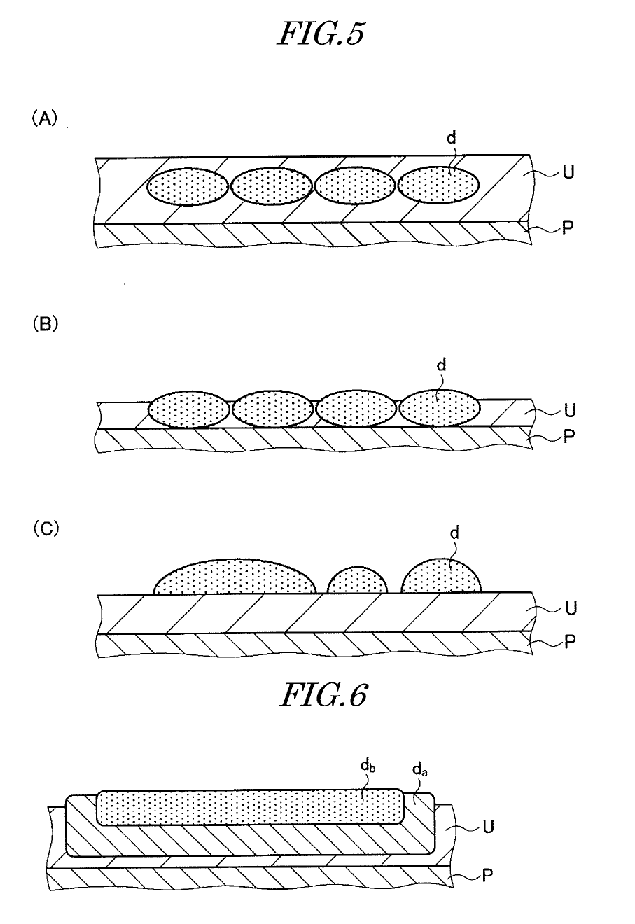

(FIG. 6) A schematic sectional view showing one example of a recording medium in which an ink composition is fired onto a semi-cured ink composition.

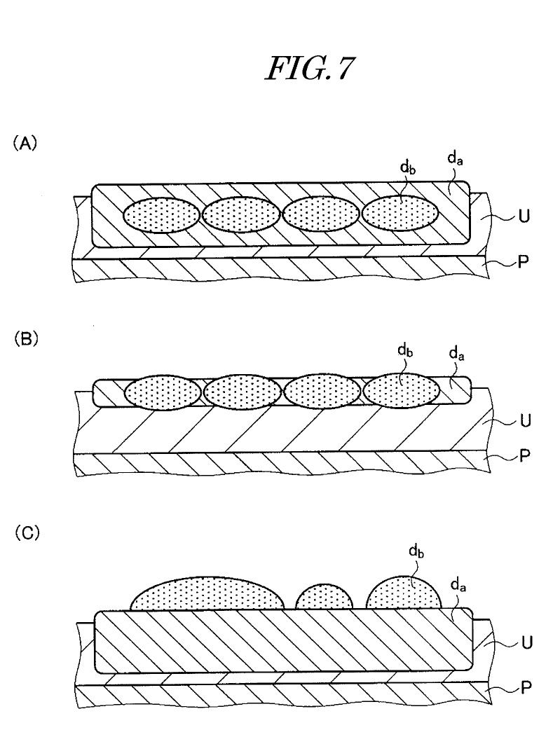

(FIG. 7) (A) and (B) are schematic sectional views showing one example of a recording medium in which an ink composition is fired onto an uncured ink composition, and (C) is a schematic sectional view showing one example of a recording medium in which an ink composition is fired onto a completely cured ink composition.

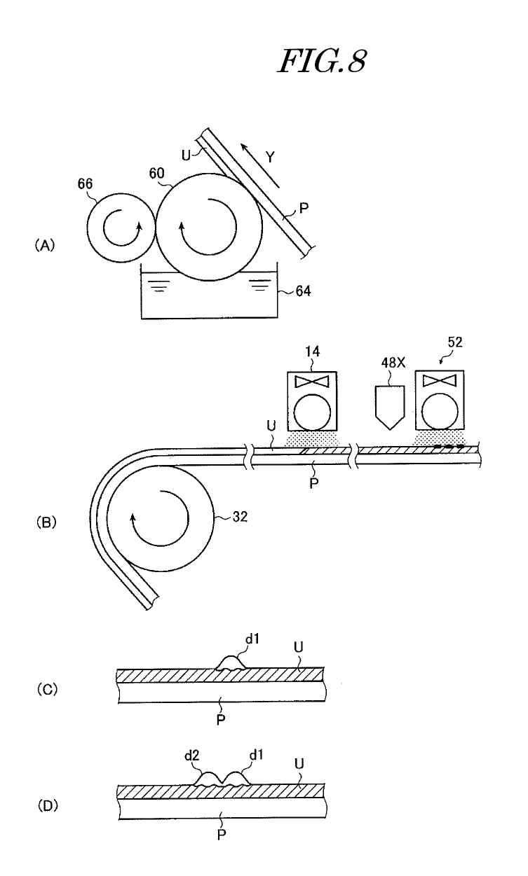

(FIG. 8) (A) to (D) are process drawings schematically showing steps of forming an image on a recording medium.

### EXPLANATION OF REFERENCE NUMERALS AND SYMBOLS

10 lnkjet recording system
12 Transport section
13 Undercoat section
14 Undercoat liquid semi-curing section
16 Image recording section
18 Image fixation section
20 Control section
22 Input device
30 Supply roll
32 Transport roll
34 Transport roll pair
36 Recovery roll
46 Recording head unit
48X, 48Y, 48C, 48M, 48K Recording head
50 Ink tank
52 UV irradiation unit
54 Final curing UV irradiation unit
56 Platen
60 Coating roll
62 Drive section
64 Reservoir dish
66 Scraper roll
67 (Scraper roll) drive section p0 68 Positioning section
70, 72 Positioning roll
80 Fluorescent lamp
82 Housing
84 Cooling mechanism (fan)
86 Bulb
88 Electrode
88a Cathode
88b Anode
89 Getter
90 Protective film
91 Reflection film
92 Phosphorfilm
94, 96 Aperture
95 Heat pipe
P Recording medium
d1, d2 Ink composition liquid droplet

### DETAILED DESCRIPTION OF THE INVENTION

The present invention is explained in detail below while also referring to the drawings.

### Inkjet Recording Method, Inkjet Recording System, and Printed Material

The inkjet recording method of the present invention comprises a step of discharging onto a recording medium (support, recording material, etc.) an ink composition comprising a vinyl ether compound, an oxirane compound and/or oxetane compound, a cationic photopolymerization initiator, and a colorant (hereinafter, also called a ‘discharge step’), and a step of curing the discharged ink composition by irradiation with UV rays by UV irradiation means comprising an aperture type hot cathode fluorescent tube having a getter in the interior thereof (hereinafter, also called a ‘curing step’).

The inkjet recording method of the present invention is a method for forming an image by an ink composition cured on a recording medium, the method comprising the discharge step and the curing step.

Furthermore, the inkjet recording system of the present invention comprises recording medium transport means, an inkjet head for discharging an ink composition comprising a vinyl ether compound, an oxirane compound and/or oxetane compound, a cationic photopolymerization initiator, and a colorant to thus form an image on a recording medium, and UV irradiation means for curing the ink composition discharged onto the recording medium by irradiation with UV rays, the UV irradiation means comprising as a UV light source an aperture type hot cathode fluorescent tube having a getter in the interior thereof.

The inkjet recording system of the present invention may suitably be used in the inkjet recording method of the present invention.

Furthermore, the printed material of the present invention is a printed material obtained by using the inkjet recording method of the present invention or the inkjet recording system of the present invention.

The discharge step is now explained.

As an inkjet recording system that can be used in the present invention, there can be cited as an example a system comprising an ink supply system, a temperature sensor, and UV irradiation means that is an aperture type hot cathode fluorescent tube having a getter in the interior.

The ink supply comprises, for example, a main tank containing the ink composition, a supply pipe, an ink supply tank immediately before an inkjet head, a filter, and a piezo system inkjet head. The piezo system inkjet head may be driven so as to discharge a multisize dot of preferably 1 to 100 pL, and more preferably 8 to 30 pL, at a resolution of preferably 320×320 to 4,000×4,000 dpi, more preferably 400×400 to 1,600×1,600dpi, and yet more preferably 720×720 dpi. Here, dpi referred to in the present invention means the number of dots per 2.54 cm.

Since it is desirable for the ink composition to be discharged at a constant temperature, a section from the ink supply tank to the inkjet head can be thermally insulated and heated. A method of controlling temperature is not particularly limited, but it is preferable to provide, for example, temperature sensors at a plurality of pipe section positions, and control heating according to the ink flow rate and the temperature of the surroundings. The temperature sensors may be provided on the ink supply tank and in the vicinity of the inkjet head nozzle. Furthermore, the head unit that is to be heated is preferably thermally shielded or insulated so that the device main body is not influenced by the temperature of the outside air. In order to reduce the printer start-up time required for heating, or in order to reduce the thermal energy loss, it is preferable to thermally insulate the head unit from other sections and also to reduce the heat capacity of the entire heated unit.

The ink composition is preferably discharged by the inkjet recording system above mentioned after being heated to preferably 25° C. to 80° C., and more preferably 25° C. to 50° C., so as to reduce the viscosity of the ink composition to preferably 3 to 15 mPa·s, and more preferably 3 to 13 mPa·s.

In particular, it is preferable to use the ink composition having an ink viscosity at 25° C. of not more than 50 mPa·s since a good dischargeability can be realized. The ink viscosity at 25° C. is more preferably 5 to 50 mPa·s. By employing this method, high discharge stability can be realized. When the viscosity at room temperature is set to be high, even when a porous recording medium is used, penetration of the ink into the recording medium can be prevented, and uncured monomer can be reduced. Furthermore, ink spreading when ink droplets have landed can be suppressed, and as a result there is the advantage that the image quality is improved.

With regard to the ink composition in the present invention, it is preferable that its component ratio is appropriately adjusted so that the viscosity is in the above-mentioned range.

The ink composition that can be used in the present invention generally has a viscosity that is higher than that of a normal ink composition or a water-based ink used for an inkjet recording ink, and variation in viscosity due to a change in temperature at the time of discharge is large. Viscosity variation in the ink composition has a large effect on changes in liquid droplet size and changes in liquid droplet discharge speed and, consequently, causes the image quality to be degraded. It is therefore necessary to maintain the ink discharge temperature as constant as possible. Therefore, in the present invention, the control range for the temperature is preferably ±5° C. of a set temperature, more preferably ±2° C. of the set temperature, and yet more preferably ±1° C. of the set temperature.

The surface tension of the ink composition at 25° C. is preferably 20 to 35 mN/m, and more preferably 23 to 33 mN/m. When recording is carried out on various types of recording medium such as polyolefin, PET, coated paper, and uncoated paper, from the viewpoint of spread and penetration, it is preferably at least 20 mN/m, and from the viewpoint of wettability it is preferably not more than 35 mN/m.

The curing step is now explained.

The ink composition discharged onto a recording medium is cured by irradiation with UV rays. This is due to the cationic photopolymerization initiator contained in the ink composition being decomposed by irradiation with UV rays, thus generating an initiating species such as an acid or a cation, which then functions so as to cause and promote a polymerization reaction.

Although it depends on the absorption characteristics of the cationic photopolymerization initiator, etc., the peak wavelength of the UV rays is for example preferably 10 to 420 nm, more preferably 200 to 400 nm, and yet more preferably 350 to 400 nm.

Furthermore, curing is suitably carried out such that the exposure area illumination intensity of the UV irradiation is preferably 10 to 4,000 mW/cm², and more preferably 20 to 2,500 mW/cm².

The UV light source in the present invention is an aperture type hot cathode fluorescent tube having a getter in the interior.

The getter referred to here is an adsorbent for gas or impurities. Disposing the getter around the cathode prevents gas or impurities within the fluorescent tube from adsorbing on a phosphor, the cathode, etc. to thus prevent non-uniformity of light intensity distribution, and enables a longer lifespan to be realized for the fluorescent lamp.

When a getter is disposed around a discharge electrode of a fluorescent lamp, in order to cause a chemical reaction thereof, depending on the type of getter it is necessary to heat the getter to on the order of a few hundred ° C. Because of this, in order to obtain heat the getter is generally mounted in the vicinity of the cathode or an area around the getter is heated externally.

Specific examples of the getter include an active metal such as Ba, Ca, or Sr, a Zr—V—Fe—Ti-based material, and Zr—Co-rare earth element. The shape of the getter is not particularly limited and may be modified appropriately as desired.

A reflection film is formed from a material that reflects light and is layered on an inner wall face of a bulb.

A phosphor film is formed from a phosphor that emits UV rays having the above-mentioned peak wavelength and is layered on the reflection film and the inner wall face of the bulb. Examples of the phosphor include phosphors described in JP-A-2006-104338, JP-A-2005-108853, etc.

The aperture type fluorescent tube referred to here is a fluorescent tube having an aperture section that is not coated with a reflection film or a phosphor film.

The hot cathode fluorescent tube referred to here is a fluorescent tube in which an electrode has a filament and thermionic emission is caused by heating this filament.

The UV light source in the present invention is a hot cathode tube, and a glass bulb preferably comprises soda-lime glass that is transparent to UV rays at 320 nm or greater or quartz glass that does not have absorption in the UV region. Furthermore, it is particularly preferably of an aperture type in which a protective film, a reflection film, and a phosphor film are provided on the glass bulb inner face by coating in sequence from a glass bulb interface, and there is an aperture face having a rectangular shape in a direction parallel to the glass bulb axis and having no reflection film or phosphor film provided thereon. Moreover, a getter for adsorbing gas is preferably mounted within the glass bulb in the vicinity of an electrode.

Furthermore, the UV irradiation device preferably has a cooling device for cooling the hot cathode tube in order to suppress the mercury vapor pressure within the glass bulb to an appropriate range.

Examples of the cooling device include a fan and a heat pipe.

Furthermore, the UV irradiation device preferably comprises a feedback mechanism that can prevent degradation during use over a long period by increasing input current and thus maintaining a constant output.

Due to the aperture type hot cathode tube having a reflection film applied thereto, UV rays generated within the bulb are released only in a specific direction, and due to the presence of an aperture face, UV rays that are generated are easily transmitted, efficient irradiation is possible, and output in the specific direction can be increased.

Furthermore, when input current is increased by feedback during use over a long period, impurities and/or impurity gas are generated from a component within the hot cathode tube, discharge intensifies, sputter etching of a cathode component, a phosphor, etc. occurs, and the lifespan of the hot cathode tube is shortened. By providing a gas adsorption getter within the tube, an effect in preventing the lifespan of the hot cathode tube from being shortened is exhibited.

The ink composition is preferably exposed to such UV (ultraviolet) rays for 0.01 to 120 sec., and more preferably 0.1 to 90 sec.

Irradiation conditions and a basic method for irradiation with UV rays are disclosed in JP-A-60-132767. Specifically, a light source is provided on either side of a head unit that includes an ink discharge device, and the head unit and the light source are made to scan by a so-called shuttle system. Irradiation with UV rays is carried out after a certain time (e.g. preferably 0.01 to 0.5 sec., more preferably 0.01 to 0.3 sec., and yet more preferably 0.01 to 0.15 sec.) has elapsed from when the ink has landed. By controlling the time from ink landing to irradiation so as to be a minimum in this way, it becomes possible to prevent the ink composition that has landed on a recording medium from spreading before being cured. Furthermore, since the ink composition can be exposed before it reaches a deep area of a porous recording medium that the light source cannot reach, it is possible to prevent monomer from remaining unreacted.

By employing such a recording method above mentioned, it is possible to maintain a uniform dot diameter for landed ink composition even for various types of recording media having different surface wettability, thereby improving the image quality. In order to obtain a color image, it is preferable to superimpose colors in order from those with a low lightness. By superimposing ink compositions in order from one with low lightness, it is easy for radiation to reach a lower ink composition, the curing sensitivity is good, the amount of residual monomer decreases, odor is reduced, and an improvement in adhesion can be expected.

In this way, the ink composition in the present invention is cured by irradiation with UV rays to thus form a image on the surface of the recording medium.

In the present invention, the recording medium is not particularly limited, and a recording medium known as a support or a recording material may be used. Examples thereof include paper, paper laminated with a plastic (e.g. polyethylene, polypropylene, polystyrene, etc.), a metal plate (e.g. aluminum, zinc, copper, etc.), a plastic film (e.g. cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinylacetal, etc.), and paper or plastic film laminated or vapor-deposited with the above metal. In the present invention, as the recording medium, a non-absorbing recording medium may suitably be used.

The recording medium transport means in the inkjet recording system of the present invention is not particularly limited, and known means may be used.

FIG. 1 is a front view showing the schematic configuration of one example of the inkjet recording system related to the present invention, FIG. 2 (A) is a longitudinal sectional view showing the schematic configuration of one example of a fluorescent lamp of a UV irradiation unit of the inkjet recording system shown in FIG. 1, and FIG. 2(B) is a sectional view along line B-B of the fluorescent lamp shown in FIG. 2(A).

As shown in FIG. 1, an inkjet recording system 10 comprises a transport section 12 for transporting a recording medium P, an undercoat section 13 for coating the recording medium P with an undercoat liquid, an undercoat liquid semi-curing section 14 for semi-curing the undercoat liquid applied onto the recording medium P, an image recording section 16 for recording an image on the recording medium P, an image fixation section 18 for fixing the image recorded on the recording medium P, and a control section 20 for controlling the discharge of ink composition liquid droplets in the image recording section 16.

Furthermore, an input device 22 is connected to the control section 20 of the inkjet recording system 10. As the input device 22, various devices for sending image data, for example, an image reader such as a scanner and an image processor such as a personal computer may be used. A method for connecting the input device 22 to the control section 20 may employ various connection methods including both wired and wireless.

The transport section 12 comprises a supply roll 30, a transport roll 32, a transport roll pair 34, and a recovery roll 36, and supplies, transports, and recovers the recording medium P.

The supply roll 30 has the recording medium P in continuous sheet form wound in roll form, and supplies the recording medium P.

The transport roll 32 is disposed on the downstream side of the supply roll 30 in the transport direction of the recording medium P, and transports the recording medium P fed out from the supply roll 30 toward the downstream side in the transport direction.

The transport roll pair 34 is a pair of rolls, is disposed on the downstream side of the transport roll 32 in a transport path of the recording medium P, holds the recording medium P that has passed the transport roll 32, and transports it toward the downstream side in the transport direction.

The recovery roll 36 is disposed on the most downstream side in the transport path of the recording medium P. The recovery roll 36 takes up the recording medium P that has been supplied from the supply roll 30, has been further transported by the transport roll 32 and the transport roll pair 34, and has passed positions corresponding to the undercoat section 13, the undercoat liquid semi-curing section 14, the image recording section 16, and the image fixation section 18.

Here, the transport roll 32, the transport roll pair 34, and the recovery roll 36 are connected to a drive section, which is not illustrated, and are rotated by this drive section.

The transport roll 32 is disposed above the supply roll 30 in the vertical direction and at a position further away from the recovery roll 36 than the supply roll 30 in the horizontal direction. Furthermore, the transport roll 32, the transport roll pair 34, and the recovery roll 36 are disposed linearly in the horizontal direction.

The transport section 12 is thus constituted; the recording medium P drawn from the supply roll 30 is transported upward while being inclined at a predetermined angle toward the side away from the recovery roll 36 relative to the vertical direction, that is, obliquely upward, the transport direction is then changed by the transport roll 32, and after passing the transport roll 32 it is transported in the horizontal direction toward the recovery roll 36.

That is, the recording medium P is withdrawn from the supply roll 30, then moved obliquely upward with the side on which an image is recorded facing down, and after passing the transport roll 32 is moved in the horizontal direction with the side on which the image is recorded facing up.

The undercoat section 13 is disposed between the supply roll 30 and the transport roll 32, that is, on the downstream side of the supply roll 30 and on the upstream side of the transport roll 32 in the transport direction of the recording medium P.

The undercoat section 13 comprises a coating roll 60 for coating the recording medium P with an undercoat liquid, a drive section 62 for rotating the coating roll 60, a reservoir dish 64 for supplying the undercoat liquid to the coating roll 60, a scraper roll 66 for adjusting the amount of undercoat liquid applied to the coating roll 60, a scraper roll drive section 67 (hereinafter, also simply called ‘drive section 67’) for rotating the scraper roll 66, and a positioning section 68 for supporting the recording medium P so that the recording medium P is at a predetermined position relative to the coating roll 60.

The coating roll 60 is disposed between the supply roll 30 and the transport roll 32 on the transport path of the recording medium P, and abuts against the downward-facing side of the recording medium P (the face on the side of the recording medium P on which an image is formed) that is being transported between the supply roll 30 and the transport roll 32.

The coating roll 60 is a roll that is longer than the width of the recording medium P, and is a so-called gravure roll, on the surface (outer periphery) of which are formed recesses at fixed intervals, that is, evenly. The shape of the recesses formed on the coating roll 60 is not particularly limited, and various shapes such as circular, rectangular, polygonal, and star-shaped are possible. Furthermore, the recesses may be formed as grooves extending along the entire periphery of the coating roll. Since the amount of undercoat liquid retained on the coating roll surface can be made constant, the coating roll preferably has a shape in which recesses are formed on the surface at fixed intervals, but it is not limited thereto, and a roll having no recesses may be used.

The drive section 62 is a drive mechanism formed from a motor, a gear for transmitting rotation of the motor to the coating roll 60, etc., and rotates the coating roll 60. The drive section 62 is not limited to the present embodiment, and various types of drive mechanism for rotating the coating roll 60 such as pulley drive, belt drive, and direct drive may be used.

As shown by the arrow in FIG. 1, the drive section 62 rotates the coating roll 60 in a direction (clockwise direction in FIG. 1) opposite to the transport direction of the recording medium P at a contact position.

The reservoir dish 64 has a dish shape with an open upper face, and the undercoat liquid is stored in its interior. The reservoir dish 64 is disposed in proximity to the coating roll 60 and beneath the coating roll 60, and part of the coating roll 60 is immersed in the undercoat liquid stored therein. Furthermore, the undercoat liquid is supplied to the reservoir dish 64 on demand from a supply tank, which is not illustrated.

The scraper roll 66 is a roll having substantially the same length as that of the coating roll 60 in the axial direction, and is disposed in a rotatable state while being in contact with the surface of the coating roll 60. More specifically, the scraper roll 66 is disposed on the downstream side of the reservoir dish 64 and on the upstream side of the recording medium P in the rotational direction of the coating roll 60.

The scraper roll 66 scrapes off surplus undercoat liquid applied to the coating roll 60 by immersion in the reservoir dish 64, thus making the amount of undercoat liquid applied to the coating roll 60 constant. In the present embodiment, apart from undercoat liquid retained by the recesses formed on the surface of the coating roll 60 the scraper roll 66 scrapes off the undercoat liquid applied to other sections of the coating roll 60, thus limiting the undercoat liquid retained in sections of the coating roll 60 that are in contact with the recording medium P to substantially only the undercoat liquid retained by the recesses.

By scraping off surplus undercoat liquid (surplus liquid) applied to the surface of the coating roll 60 and making the amount of undercoat liquid applied to the surface of the coating roll 60 constant, an undercoat layer can be formed on the recording medium P more uniformly.

As shown by the arrow in FIG. 1, the drive section 67 rotates the scraper roll 66 in a direction in which it rotates together with the coating roll 60, that is, a direction (anticlockwise in FIG. 1) in which the direction of movement of the surface at the contact position with the coating roll 60 is the same as the direction of movement of the coating roll 60. As the drive section 67, various drive mechanisms for rotating a roll such as gear drive, pulley drive, belt drive, and direct drive may be used in the same manner as for the drive section 62. By rotating the scraper roll 66 in a direction in which it rotates together with the coating roll 60 by means of the drive section 67, it is possible to prevent wear of the scraper roll 66 and the coating roll 60, reduce the frequency of replacement of the scraper roll 66 and the coating roll 60, and improve the durability of the system.

Since the durability of the system can be improved, it is preferable to scrape off surplus liquid attached to the coating roll 60 by a scraper roll as in the present embodiment, but the method is not limited thereto, and surplus liquid may be scraped off by a method employing a blade in which scraping is carried out by contacting the blade with the coating roll 60.

The positioning section 68 comprises positioning rolls 70 and 72, and supports the recording medium P so that the recording medium P at the contact position with the coating roll 60 is at a predetermined position.

The positioning rolls 70 and 72 are disposed on the upstream side and the downstream side of the coating roll 60 respectively, so that the coating roll 60 is interposed therebetween in the transport direction of the recording medium P, on the side opposite to the coating roll 60 relative to the recording medium P, and support the recording medium P from the face of the recording medium P on the opposite side to that on which an image is formed (the face that is coated with an undercoat liquid).

The coating roll 60 and positioning rolls 70 and 72 of the undercoat section 13 are preferably provided with a positioning mechanism for fixing their mutual positions. Providing the positioning mechanism can prevent displacement of the positional relationship between the coating roll 60 and the positioning rolls 70 and 72 from occurring.

As the positioning mechanism, the constitution may be such that members for supporting the coating roll 60 and the positioning rolls 70 and 72 are made to contact each other and, for example, a mechanism for making bearings of the members contact each other or a mechanism for making fixing members for fixing the bearings contact each other may be used.

The undercoat section 13 is constituted as above, and the drive section 62 rotates the coating roll 60 in a direction opposite to the transport direction of the recording medium P. The surface of the rotating coating roll 60 is immersed in the undercoat liquid stored in the reservoir dish 64. Furthermore, a section of the coating roll 60 immersed in the undercoat liquid subsequently abuts against the scraper roll 66 due to rotation of the coating roll 60, the amount of undercoat liquid retained by the surface is made constant, and the coating roll 60 then contacts the recording medium P, thus coating the recording medium P with the undercoat liquid. In this way, by rotating the coating roll 60 in a direction opposite to the transport direction of the recording medium P to coat the recording medium P with the undercoat liquid, a layer of the undercoat liquid with a smoothed, uniform, and well coated surface (hereinafter, also called an ‘undercoat layer’) is formed on the recording medium P. Furthermore, the coating roll 60 that has contacted the recording medium P further rotates and is immersed again in the reservoir dish 64.

The undercoat liquid semi-curing section 14 is now explained.

The undercoat liquid semi-curing section 14 comprises a UV irradiation unit, and is disposed so as to face the recording medium P.

The UV irradiation unit comprises a fluorescent lamp for generating UV rays; a housing that is disposed so as to surround the fluorescent lamp, has an aperture formed on the recording medium P side, and reflects light emitted from the fluorescent lamp; and a cooling mechanism that is disposed within the housing and feeds air toward the fluorescent lamp to cool the fluorescent lamp, the UV irradiation unit radiating UV rays toward the recording medium P. This UV irradiation unit is explained later in detail for the image curing section.

The undercoat liquid semi-curing section 14 irradiates with UV rays the entire region in the width direction of the recording medium P, which is passing the position opposite and whose surface has been coated with the undercoat liquid, thereby semi-curing the undercoat liquid applied to the surface of the recording medium P. Semi-curing of the undercoat liquid is explained later in detail.

The image recording section 16 for discharging ink composition liquid droplets onto the recording medium P so as to record an image and the image fixation section 18 for curing the image formed on the recording medium P by the image recording section 16 so as to fix it on the recording medium P are now explained.

The image recording section 16 comprises a full-line type recording head unit 46 and an ink tank 50.

The recording head unit 46 comprises recording heads 48X, 48Y, 48C, 48M, and 48K (hereinafter, also called simply ‘recording heads 48’ when these five recording heads are referred to together).

Needless to say, the recording head unit 46 may employ one other than the full-line type, and specifically a shuttle scan type.

The recording heads 48 are disposed from the upstream to the downstream along the transport direction of the recording medium P in the sequence recording head 48X, recording head 48Y, recording head 48C, recording head 48M, and recording head 48K. Furthermore, the recording heads 48 are disposed so that the extremity of an ink discharge part faces the transport path of the recording medium P, that is, it faces the recording medium P that is being transported on the transport path by means of the transport section 12 (hereinafter, also simply called ‘facing recording medium P’).

The recording heads 48 are of a full-line type in which a large number of discharge outlets (nozzles, ink discharge parts) are disposed at fixed intervals over the whole region in a direction perpendicular to the transport direction of the recording medium P, that is, in the width direction of the recording medium P, are piezo type inkjet heads, and are connected to the control section 20 and an ink tank 50, which are described later. The recording heads 48 are controlled in terms of the amount of ink composition liquid droplets discharged and the discharge timing by means of the control section 20. Furthermore, the recording heads 48X, 48Y, 48C, 48M, and 48K discharge ink compositions of special color (X), yellow (Y), cyan (C), magenta (M), and black (K) respectively.

By discharging ink compositions of each color of special color (X), yellow (Y), cyan (C), magenta (M), and black (K) toward the recording medium P from the recording heads 48 while transporting the recording medium P by means of the transport section 12, a color image can be formed on the recording medium P.

In the present embodiment, the recording head is of a piezo element (piezoelectric element) type, but it is not limited thereto, and various types of recording heads, such as a thermal jet type in which a bubble is formed by heating an ink composition by means of a heating element such as a heater and an ink composition liquid droplet is fired by the pressure thereof, may be applied instead of the piezo type.

As the special color ink discharged from the recording head 48X, various white, orange, violet, green, etc. inks may be used. The ink discharged from the recording head 48X is not limited to one color, and may be a plurality of colors. Furthermore, the order in which the recording heads 48 are arranged is not limited to the present embodiment, and various orders of arrangement may be employed.

The ink discharged from the recording head of the present embodiment is a UV curing ink.

The ink tank 50 is provided so as to correspond to each recording head 48. The ink tank 50 stores an ink composition of the respective color corresponding to the recording head, and supplies it to the recording head 48 corresponding to the ink composition stored.

Furthermore, a plate-shaped platen 56 is disposed at a position that faces the recording heads 48 on the side of the recording medium P on which an image is not formed.

The platen 56 supports the transported recording medium P at a position opposite the recording heads on the side on which an image is not formed, that is, the side opposite to the face of the recording medium P on which the recording head unit 46 is disposed. This enables the distance between the recording medium P and the recording heads to be maintained constant, and a high quality image can be formed on the recording medium P.

The shape of the platen 56 is not limited to a plate shape, and may be a curved shape protruding toward the recording head side. In this case, the recording heads 48 are disposed so as to have a constant distance from the platen.

The image fixation section 18 comprises a plurality of UV irradiation units 52 and a final curing UV irradiation unit 54; an image formed on the recording medium P by means of the recording head unit 46 is irradiated with UV rays, and the image (that is, the ink composition) is semi-cured by the plurality of UV irradiation units 52 and cured by the final curing UV irradiation unit 54, thus fixing the image.

The plurality of UV irradiation units 52 are disposed on the transport path of the recording medium P on the downstream side of each of the recording heads 48X, 48Y, 48C, and 48M. Furthermore, the final curing UV irradiation unit 54 is disposed on the downstream side of the recording head 48K on the transport path of the recording medium P. That is, the final curing UV irradiation unit 54 is disposed on the downstream side of the recording head that is disposed on the most downstream side on the transport path of the recording medium P.

That is, the recording heads, the UV irradiation unit 52, and the final curing UV irradiation unit 54 are disposed as shown in FIG. 1 from the upstream to the downstream of the transport path in the sequence recording head 48X, UV irradiation unit 52, recording head 48Y, UV irradiation unit 52, recording head 48C, UV irradiation unit 52, recording head 48M, UV irradiation unit 52, recording head 48K, and final curing UV irradiation unit 54.

The UV irradiation unit 52 and the final curing UV irradiation unit 54 are different in terms of the unit size, the target of irradiation with UV rays, and the degree of curing. Specifically, they are different only in that the UV irradiation unit 52 semi-cures an image formed by the recording heads, and the final curing UV irradiation unit 54 radiates light that has higher intensity than that of the other UV irradiation units and reliably cures an image of the undercoat liquid and various types of inks applied on the recording medium P; since the unit constitution is basically the same as that of the UV irradiation unit 52, the UV irradiation unit 52 is explained as being representative thereof.

Moreover, since the UV irradiation units 52 have the same constitution, one of the UV irradiation units 52 is explained below by reference to FIG. 1 and FIGS. 2(A) and (B).

The UV irradiation unit 52 comprises a fluorescent lamp 80 for generating UV rays, a housing 82 that is disposed so as to surround the fluorescent lamp 80 and has an aperture formed on the recording medium P side, and a cooling mechanism 84 that is disposed within the housing 82 and feeds air to the fluorescent lamp 80 to thus cool the fluorescent lamp 80, the unit 52 being disposed so as to face the transport path of the recording medium P.

The fluorescent lamp 80 is a linear light source for radiating UV rays, and is disposed so that its axial direction (that is, a direction along which it extends) is perpendicular to the transport direction of the recording medium P. The fluorescent lamp 80 is longer than the size in the width direction of the recording medium P, and is disposed across the whole region in the width direction of the recording medium P.

As shown in FIGS. 2(A) and (B), the fluorescent lamp 80 comprises a bulb 86, an electrode 88, a protective film 90, a reflection film 91, and a phosphor film 92.

The bulb 86 is a tubular member (or a cylindrical member) produced using soda glass, quartz glass (germicidal glass), etc. as a material. Examples of the bulb 86 include a tube having a length of 500 mm to 800 mm. The tube diameter of the bulb 86 is for example, φ 15.5 mm, 20 mm, 25.5 mm, 28 mm, 32 mm, 38 mm, etc.

As shown in FIG. 2 (B), the electrodes 88 comprise a filament-form cathode 88a and an anode 88b having a shape surrounding the cathode 88a, are exposed within a space formed by the bulb 86, and are disposed at opposite ends of the bulb 86. Furthermore, a getter 89 is mounted on the surface of the anode 88b by vapor deposition.

The interior of the bulb 86 is vacuum-sealed by the bulb 86 and the electrodes 88 disposed at the opposite ends of the bulb 86, and mercury, etc. is encapsulated in the interior.

The protective film 90 is layered on an inner wall face of the bulb 86, and retains the reflection film 91 and the phosphor film 92. The phosphor film 92 is formed from a phosphor that generates UV rays of 280 to 400 nm.

In this way, the fluorescent lamp 80 is constituted by layering the bulb 86, the protective film 90, the reflection film 91, and the phosphor film 92 from the outside toward the center.

Furthermore, as shown in FIG. 2(B), the reflection film 91 and the phosphor film 92 have apertures 94 and 96 respectively formed on the recording medium P side (the lower side in FIG. 2(B)).

When an aperture angle of the aperture of the reflection film 91 and the phosphor film 92 is defined as γ, the reflection film 91 and the phosphor film 92 preferably have a shape such that the aperture angle 65 satisfies 30°≦γ≦90°. The aperture angle referred to here is the angle formed, on a cross-section of the fluorescent lamp 80 (a face perpendicular to the longitudinal direction), between a line segment linking the center of the cross-section (that is, the center of the reflection film 91 or the phosphor film 92 formed on the circumference) and one end of the aperture and a line segment linking the center of the cross-section and the other end of the aperture.

The angle formed by the reflection film 91 and the angle formed by the phosphor film 92 are not limited to the above-mentioned angles that exactly coincide with each other, and for example as shown in FIG. 2(C) an arrangement in which an aperture angle α of the aperture of the reflection film 91 is larger than an aperture angle β of the aperture of the phosphor film 92 can suitably be used.

In this case, the shape is preferably such that the aperture angle α and the aperture angle β satisfy β<α, 60°≦α≦150° and 30°≦β≦90°.

The fluorescent lamp 80 is constituted as above, and when current is passed through the electrode 88 (filament thereof: cathode 88a) so as to preheat it, electrons are released from an emitter (applied to the filament) that has attained a high temperature and collide with mercury atoms that are encapsulated in the interior of the bulb 86, and the mercury generates UV rays. Subsequently, the UV rays thus generated hit the phosphor film 92 to thus emit light at each wavelength. The light thus emitted is then emitted toward the recording medium P through the aperture 94 directly or after being reflected by the reflection film 91.

In the fluorescent lamp 80 of the present embodiment, the getter 89 is mounted on the surface of the anode 88b by vapor deposition. As described above, with regard to the getter 89, when the current is increased in order to improve the output, the temperature of the cathode 88a can reach 1,000° C. or above, and there is conventionally the problem that the getter 89 itself and a member mounted thereon vaporize and adhere to the inner face, etc. of the bulb 86, but in the fluorescent lamp 80 of the present embodiment this is dealt with by disposing a cooling mechanism (fan) for cooling air (the cooling mechanism 84 of the UV irradiation unit 52) in the vicinity of the electrode 88 (here, in the vicinity of and above the electrode 88).

That is, in the fluorescent lamp 80 of the present embodiment, as shown in FIG. 2(A), the constitution is such that heat generated by the electrode 88 is dissipated by disposing the cooling mechanism (fan) 84 in the vicinity of and above the electrode 88 at each of the opposite ends of the fluorescent lamp 80 and rotating it at an appropriate rotational speed. In accordance with such a constitution, it is possible to dissipate the heat generated by the electrode 88 and suppress any increase in the temperature of the electrode 88, and it becomes possible to suppress the temperature of the electrode 88 to within a range in which the getter 89 and a member mounted thereon do not vaporize, thereby solving the problem of vaporized material adhering to the inner face, etc. of the bulb 86 and blackening the inner face of the bulb 86.

In the fluorescent lamp 80 of the present embodiment, measures are taken by disposing the cooling air cooling mechanism (fan) 84 in order to cool the vicinity of the electrode 88 of the bulb 86, but the cooling method is not limited thereto, and other than the above as shown, for example, in FIG. 3, a constitution in which a getter and a member mounted thereon are cooled by disposing a heat pipe 95 along an outer wall of a bulb 86 around two electrodes 88 of the bulb 86 may suitably be used. Here, as the heat pipe 95, various types of media that have a required capacity (cooling capacity) may be used appropriately.

Referring back to FIG. 1, explanation of the overall constitution of the UV irradiation unit 52 is continued.

The housing 82 of the UV irradiation unit 52 has a parallelepiped box shape, and is disposed so as to surround the periphery of the fluorescent lamp 80. The housing 82 has an open face on the recording medium P side. That is, the face of the housing 82 on the recording medium side is an aperture, and light emitted by the fluorescent lamp 80 passes through the aperture of the housing 82 and irradiates the recording medium P.

The cooling mechanism 84 is an air blower such as the above-mentioned cooling fan or a blower, and is disposed on the side, opposite to the recording medium P side, of the fluorescent lamp 80 within the housing 82 (that is, the upper side of the fluorescent lamp 80 in FIG. 1). The cooling mechanism 84 cools the fluorescent lamp 80 by blowing air toward the fluorescent lamp 80.

The cooling mechanism 84 further comprises a temperature sensor for detecting the temperature of the fluorescent lamp 80, and maintains the temperature of the fluorescent lamp 80 at a constant temperature by adjusting the amount of air and the time for which air is blown so as to adjust the amount of cooling (amount of air blown, time for which air is blown, etc.).

The housing 82 preferably has an aperture in an upper part or a side face, the aperture taking in air that is blown by the cooling mechanism 84 to the fluorescent lamp 80.

The UV irradiation unit 52 is basically constituted as described above.

The control section 20 is connected to the recording heads 48 of the recording head unit 46, converts image data sent from the input device 22 into a drawing signal, controls the discharge/non-discharge of the ink composition of the recording heads 48, and forms an image on the recording medium P.

The inkjet recording system 10 is basically constituted as described above.

The ‘semi-curing of the undercoat liquid’ and ‘semi-curing of the ink composition’ are explained below.

In the present invention, ‘semi-curing of the undercoat liquid’ means partial curing (partially cured; partial curing) and refers to a state in which the undercoat liquid is partially cured but not completely cured. When the undercoat liquid applied on top of the recording medium P is semi-cured, the degree of curing may be nonuniform; preferably curing proceeds in the depth direction of the undercoat liquid. Here, in the present embodiment, the undercoat liquid being semi-cured is an undercoat liquid which forms an undercoat layer.

For example, when a cationically polymerizable undercoat liquid is cured in humid air, since there is inhibition of cationic polymerization by moisture, curing progresses in the interior of the undercoat liquid, and curing on the surface tends to be delayed.

By using this cationically polymerizable undercoat liquid under humid conditions where there is inhibition of cationic polymerization so as to partially photocure it, the degree of curing of the undercoat liquid can be made higher in the interior than the exterior.

In this way, by semi-curing the undercoat liquid and firing the ink composition onto the semi-cured undercoat liquid, a technical effect that is preferable for the quality of the resulting printed material can be obtained. Furthermore, the operational mechanism can be confirmed by examination of a cross-section of the printed material.

Semi-curing of the undercoat liquid (that is, the undercoat layer formed on the recording medium P by the undercoat liquid) is explained in detail below. A high concentration area when about 12 pL of an ink composition (that is, an ink composition liquid droplet) is fired on a thickness of about 5 μm of semi-cured undercoat liquid provided on the recording medium P is explained as one example.

FIG. 4 is a schematic sectional view showing one example of the recording medium in which an ink composition is fired onto a semi-cured undercoat liquid, FIGS. 5(A) and (B) are schematic sectional views showing one example of the recording medium in which an ink composition is fired onto uncured undercoat liquids, and FIG. 5(C) is a schematic sectional view showing one example of the recording medium in which an ink composition is fired onto an undercoat liquid that, from a desired semi-cured state, is further cured so as to be in from an advanced state of cure to a completely cured state, thus forming a solid printed surface.

In accordance with the present invention, semi-curing the undercoat liquid makes the degree of curing on the recording medium P side higher than that of the surface layer. In this case, three features are observed. That is, when an ink composition d is fired at a semi-cured undercoat liquid U as shown in FIG. 4, (1) part of the ink composition d is exposed on the surface of the undercoat liquid U, (2) part of the ink composition d sinks into the undercoat liquid U, and (3) there is undercoat liquid between the lower side of the ink composition d and the recording medium P.

In this way, when an ink composition is fired at the undercoat liquid, if the undercoat liquid and the ink composition satisfy the conditions (1), (2), and (3) above, it can be said that the undercoat liquid is in a semi-cured state.

Semi-curing the undercoat liquid, that is, curing the undercoat liquid so as to satisfy the conditions (1), (2), and (3) above, enables the ink composition (that is, ink composition liquid droplets) fired at high density to be connected to each other to form a film layer of the ink composition (that is, ink composition film, ink composition layer), thereby giving uniform and high color density.

On the other hand, when an ink composition is fired at an uncured undercoat liquid, as shown in FIG. 5(A) all of the ink composition d sinks into the undercoat liquid U and/or as shown in FIG. 5(B) there is no undercoat liquid U in a layer beneath the ink composition d.

In this case, even if an ink composition is applied at high density, since liquid droplets are isolated from each other, the color density is decreased.

When a droplet of an ink composition is fired onto a completely cured undercoat liquid layer, the ink composition d does not sink into the undercoat liquid U, as shown in FIG. 5(C).

In this case, interference between fired droplets might occur, a uniform film layer of the ink composition cannot be formed, and a high color reproduction cannot be achieved (i.e., this leads to a decrease in color reproduction).

Here, from the viewpoint of forming an uniform ink composition coating layer without ink liquid droplets being isolated from each other when the droplets are applied to a high density and from the viewpoint of suppressing the occurrence of fired droplet interference, the amount of the uncured undercoat liquid (i.e., undercoat layer) per unit area is preferably smaller, and more preferably sufficiently smaller than the maximum amount of ink composition droplets applied per unit area. That is, the relationship between the weight of uncured undercoat liquid layer per unit area Mu (also referred to as M (undercoat liquid)) and the maximum weight of the ink liquid applied per unit area is mi (also referred to as m (ink composition)) preferably satisfies (mi/30)<Mu<mi, more preferably satisfies (mi/20)<Mu<(mi/3), and especially preferably satisfies (mi/10)<Mu<(mi/5). As used herein, “the maximum weight of the ink composition applied per unit area” refers to the maximum weight per color.

By setting (mi/30)<Mu, fired droplet interference can be prevented from occurring and moreover a high dot size reproducibility can be achieved. By setting Mu<mi, the ink composition can be uniformly formed and a decrease in density is prevented.

Here, the weight of not cured undercoat liquid layer per unit area is determined by the transfer test described below. Specifically, after the semi-curing step is completed (e.g., after irradiating with actinic radiation) and before firing droplets of an ink composition droplet, a permeable medium such as plain paper is pressed against the semi-cured undercoat liquid layer, and the amount of undercoat liquid transferred to the permeable medium is determined by weight measurement. The measured value is defined as the weight of uncured undercoat layer.

For example, when the maximum amount of ink composition discharged is 12 pL per pixel (dot) at a fired droplet density of 600×600 dpi, the maximum weight mi of the ink composition applied per unit area is 7.37×10⁻⁴ mg/cm² (here, it is assumed that the density of the ink composition is about 1.1 g/cm³). In this case, the weight Mu per unit area of uncured undercoat liquid layer is therefore preferably at least 2.46×10⁻⁵ mg/cm² but no greater than 7.37×10⁻⁴ mg/cm² per unit area, more preferably at least 3.69×10⁻⁵ mg/cm² but no greater than 2.46×10⁻⁴ mg/cm², and particularly preferably at least 7.37×10⁻⁵ mg/cm² but no greater than 1.47×10⁻⁴ mg/cm².

In the present invention, ‘semi-curing of the ink composition’ means, in the same manner as for the undercoat liquid, partial curing (partially cured), and the ink composition (that is, a coloring liquid) is partially cured or is not completely cured. When the ink composition discharged onto the undercoat liquid is semi-cured, the degree of curing may be nonuniform, and curing of the ink composition preferably progresses in the depth direction. In the present embodiment, the semi-cured ink composition is ink composition liquid droplets that land on the undercoat layer or the recording medium and form an ink layer.

By semi-curing the ink composition and firing an ink composition having a different color from that of the above onto the semi-cured ink composition, a technical effect that is preferable for the quality of the resulting printed material can be obtained. Furthermore, the operational mechanism can be confirmed by examination of a cross-section of the printed material.

Semi-curing of the ink composition (that is, ink composition liquid droplets that have landed on the recording medium or the undercoat layer, or an ink composition layer formed by the landed ink composition liquid droplets) is explained below.

FIG. 6 is a schematic sectional view showing a recording medium in which an ink composition db is fired onto a semi-cured ink composition dₐ, FIGS. 7(A) and (B) are schematic sectional views showing one example of a recording medium in which an ink composition db is fired onto an uncured ink composition dₐ, and FIG. 7(C) is a schematic sectional view showing one example of a recording medium in which an ink composition is fired onto a completely cured ink composition.

When a secondary color is formed by firing an ink composition dₐ and then firing an ink composition d_{b} onto the ink composition dₐ, it is preferable to apply the ink composition d_{b} on the ink composition dₐ in a semi-cured state.

The semi-cured state of the ink composition dₐ referred to here is the same as the semi-cured state of the above-mentioned undercoat liquid, and as shown in FIG. 6, when an ink composition d_{b} is fired onto an ink composition dₐ, (1) part of the ink composition d_{b} is exposed on the surface of the ink composition dₐ, (2) part of the ink composition d_{b} sinks into the ink composition dₐ, and (3) the ink composition dₐ is present in a layer beneath the ink composition d_{b}.

In this way, by semi-curing the ink composition, it is possible to suitably layer a cured film (colored film A) of the ink composition dₐ and a cured film (colored film B) of the ink composition d_{b}, and good color reproduction becomes possible.

On the other hand, when an ink composition d_{b} is fired onto an uncured ink composition dₐ, as shown in FIG. 7(A) all of the ink composition d_{b} sinks into the ink composition dₐ and/or as shown in FIG. 7(B) there is no ink composition dₐ in a layer beneath the ink composition d_{b}. In this case, even if ink composition d_{b} liquid droplets are applied at high density, since liquid droplets are isolated from each other, the saturation of the secondary color is decreased.

Furthermore, when an ink composition d_{b} is fired onto a completely cured ink composition dₐ, as shown in FIG. 7(C) the ink composition d_{b} does not sink into the ink composition dₐ. In this case, interference between fired droplets might occur, a uniform film layer of the ink composition cannot be formed, and color reproduction is thus degraded.

In the case in which liquid droplets of the ink composition d_{b} are applied at high density, from the viewpoint of forming a uniform film layer of the ink composition d_{b} without liquid droplets being isolated from each other and from the viewpoint of suppressing the occurrence of fired droplet interference, the amount of the uncured part of the ink composition dₐ per unit area is preferably smaller than the maximum amount of liquid droplets of the ink composition d_{b} applied per unit area, and more preferably sufficiently smaller. That is, a weight Mdₐ (also called M (ink composition A)) of the uncured part of the ink composition dₐ layer per unit area and the maximum weight md_{b} (also called m (ink composition B)) of the ink composition discharged per unit area preferably satisfy (md_{b}/30)<Mdₐ<md_{b}, more preferably (md_{b}/20)<Mdₐ<(md_{b}/3), and particularly preferably (md_{b}/10)<Mdₐ<(md_{b}/5).

By setting (md_{b}/30)<Mdₐ, it is possible to prevent the occurrence of interference between fired droplets and improve the dot size reproducibility. By setting Mdₐ<md_{b}, it is possible to uniformly form a film layer of the ink composition dₐ and prevent the density from degrading.

The weight of the uncured ink composition dₐ per unit area is measured in a similar way by the transfer test described above. Specifically, after the semi-curing step of ink composition layer is completed (e.g. after irradiating with actinic radiation) and before firing droplets of an ink composition d_{b}, a permeable medium such as plain paper is pressed against the semi-cured ink composition dₐ layer, and the amount of ink composition dₐ transferred to the permeable medium is determined by weight measurement. The measured value is defined as the weight of uncured undercoat layer.

For example, when the maximum amount of ink composition d_{b} discharged is 12 pL per pixel (dot) at a fired droplet density of 600×600 dpi, the maximum weight md_{b} of the ink composition d_{b} applied per unit area is 7.37×10⁻⁴ mg/cm² (here, it is assumed that the density of the ink composition is about 1.1 g/cm³). In this case, the weight Mdₐ per unit area of uncured undercoat liquid layer is therefore preferably the amount of ink composition dₐ layer transferred is therefore preferably at least 2.46×10⁻⁵ mg/cm² but no greater than 7.37×10^{31 4} mg/cm² per unit area, more preferably at least 3.69×10⁻⁵ mg/cm² but no greater than 2.46×10⁻⁴ mg/cm², and particularly preferably at least 7.37×10⁻⁵ mg/cm² but no greater than 1.47×10⁻⁴ mg/cm².

When a semi-cured state of the undercoat liquid and/or the ink composition is realized by a polymerization reaction of a polymerizable compound that is initiated by irradiation with actinic radiation or heating, from the viewpoint of improvement of scratch resistance of a printed material, it is preferable for the degree of unpolymerization (A (after polymerization)/A (before polymerization)) to be at least 0.2 but no greater than 0.9, more preferably at least 0.3 but no greater than 0.9, and particularly preferably at least 0.5 but no greater than 0.9.

Here, A (before polymerization) denotes the absorbance of an IR peak due to a polymerizable group before a polymerization reaction, and A (after polymerization) denotes the absorbance of an IR peak due to a polymerizable group after a polymerization reaction.

For example, when the polymerizable compound contained in the undercoat liquid and/or the ink composition is an oxetane compound, an absorption peak due to a polymerizable group (oxetane ring) can be observed at around 986 cm⁻¹, and the degree of non-polymerization is preferably defined by the absorbance of the peak. When the polymerizable compound is an epoxy compound, an absorption peak due to a polymerizable group (epoxy group) can be observed at around 750 cm⁻¹, and the degree of non-polymerization is preferably defined by the absorbance of the peak.

Moreover, as means for measuring an infrared absorption spectrum, a commercial infrared spectrophotometer may be used; either a transmission type or a reflectance type may be used, and it is preferably selected as appropriate depending on the form of a sample. For example, an FTS-6000 infrared spectrophotometer manufactured by Bio-Rad Laboratories, Inc. may be used for measurement.

Furthermore, in the case of a curing reaction due to a vinyl ether compound, the degree of non-polymerization may be measured quantitatively from the degree of conversion of the vinyl ether group.

Moreover, as a method for semi-curing an undercoat liquid and/or an ink composition, there can be cited a known viscosity increasing method such as a method in which UV rays are applied to an undercoat liquid and/or an ink composition to cause a curing reaction.

The method by which UV rays are applied to cause a semi-curing reaction referred to here is a method in which a polymerization reaction of a polymerizable compound on the surface of the undercoat liquid and/or ink composition applied onto the recording medium is carried out insufficiently. Due to the influence of oxygen in the air, the polymerization reaction on the surface of the undercoat liquid and/or ink composition is easily inhibited compared with the interior thereof. By controlling the conditions of application of UV rays, it is therefore possible to cause a semi-curing reaction of the undercoat liquid and/or ink composition.

The amount of energy necessary for semi-curing the undercoat liquid and/or the ink composition depends on the type and content of a polymerization initiator, but it is preferably on the order of 1 to 500 mJ/cm² when energy is provided by UV rays.

By now explaining the operation of the inkjet recording system 10, that is, recording on the recording medium P, the inkjet recording method of the present invention and the inkjet recording system of the present invention are explained in further detail.

FIGS. 8(A) to (D) are process drawings schematically showing steps of forming an image on a recording medium.

The recording medium P fed out from the supply roll 30 is first transported in a predetermined direction (direction Y in FIG. 1) by rotation of the transport roll 32 and the transport roll pair 34 or rotation of the supply roll 30 and the recovery roll 36. Here, the recording medium P of the present embodiment is, as described above, continuous paper having at least a predetermined length, and the recording medium P is transported continuously.

The recording medium P drawn from the supply roll 30 makes contact with the coating roll 60 of the undercoat section 13 as shown in FIG. 8(A), and the surface thereof is coated with an undercoat liquid thus forming an undercoat layer U. The coating roll 60 is rotated by the drive section 62 in a direction opposite to the transport direction of the recording medium P.

The recording medium P that has been coated with the undercoat liquid and has had the undercoat layer U formed thereon is further transported by the transport roll 32 and the transport roll pair 34 of the transport section 12, and passes a position opposite the undercoat liquid semi-curing section 14.

As shown in FIG. 8(B), in the undercoat liquid semi-curing section 14, the recording medium P having the undercoat liquid coated thereon and passing the position opposite is irradiated with UV rays, thus semi-curing the undercoat layer U on the recording medium P.

The recording medium P with the semi-cured undercoat liquid is further transported by the transport roll 32 and the transport roll pair 34 of the transport section 12, and passes a position opposite the recording head 48X.

The recording head 48X discharges ink composition liquid droplets from the discharge outlet, and forms an image on the recording medium P that is being transported by the transport section 12 and is passing the position opposite.

Specifically, the recording head 48X discharges a first ink composition liquid droplet d1 onto the recording medium P. The first ink composition liquid droplet d1 discharged from the recording head 48X lands on the surface of the undercoat layer U as shown in FIG. 8(C). Since the undercoat layer U is in a semi-cured state and the surface thereof is not cured, it easily blends with the ink composition liquid droplet d1.

Furthermore, as shown in FIG. 8(D), a second ink composition liquid droplet d2 is fired in the vicinity of the landing position of the first ink composition liquid droplet d1 that has been fired first. In this process, since the undercoat layer U is in a semi-cured state and the surface thereof is not cured, it easily blends with the ink composition liquid droplet d2.

In this way, when the ink composition liquid droplet d1 and the ink composition liquid droplet d2 are made to land in the vicinity of each other on the recording medium P, although a force acts to make the ink composition liquid droplet d1 and the ink composition liquid droplet d2 coalesce, since the undercoat layer U is semi-cured and has increased viscosity, it exhibits a force that resists the coalescence of the ink composition liquid droplets, thereby suppressing interference between ink composition liquid droplets that have landed on the recording medium P.

In this way, in accordance with control by the control section 20, a plurality of ink composition liquid droplets are discharged from the recording head 48X and made to land on the recording medium P, thus forming an image.

The recording medium P having an image formed thereon by the recording head 48X is further transported by the transport section 12, and passes a position opposite the UV irradiation unit 52 disposed on the downstream of the recording head 48X.

The UV irradiation unit 52 irradiates with UV rays the recording medium P passing the position opposite, thus semi-curing the image formed on the recording medium P by the recording head 48X, that is, semi-curing the ink composition liquid droplets that have landed on the recording medium.

The constitution of the UV irradiation unit 52 is such that, as shown in FIGS. 2(A) and (B), heat generated by the electrode 88 is dissipated by disposing the cooling mechanisms (fans) 84 in the vicinity of and above the electrodes 88 at opposite ends of the fluorescent lamp 80 and rotating them at an appropriate rotational speed. In accordance with such a constitution, heat generated by the electrode 88 is air-cooled/dissipated to thus suppress the temperature of the electrode 88 to within a range that prevents vaporization of the getter 89 and a member mounted thereon, and the problem of vaporized material adhering to the inner face, etc. of the bulb 86 and blackening the inner face of the bulb 86 is thereby solved.

Furthermore, by maintaining the temperature of the fluorescent lamp 80 at a constant level by means of the cooling mechanism 84, it is possible to prevent the intensity of light emitted from the fluorescent lamp 80 from changing depending on the temperature, and the intensity of light emitted can be made constant. This enables an ink and/or an undercoat liquid to be semi-cured or cured stably with a constant light intensity.

The cooling mechanism 84 preferably reduces the temperature of the surface of the fluorescent lamp 80, specifically, the surface thereof on the side opposite to the recording medium P side, to at least 30° C. but no greater than 60° C. with a variation of within 5° C. By maintaining the temperature within the above-mentioned range, the intensity of light emitted from the fluorescent lamp 80 can be made constant at high output.

Subsequently, the recording medium P is further transported and passes in sequence positions opposite the recording head 48Y, the UV irradiation unit 52, the recording head 48C, the UV irradiation unit 52, the recording head 48M, the UV irradiation unit 52, and the recording head 48K. Each time the recording medium P passes the positions opposite the recording head and the UV irradiation unit of each color an image is formed and the image thus formed is semi-cured in the same manner as in the case when it passes the positions opposite the recording head 48X and the UV irradiation unit 52.

After an image is formed by the recording head 48K, the recording medium P passes a position opposite the final curing UV irradiation unit 54.

The final curing UV irradiation unit 54 irradiates the recording medium P with UV rays having a higher intensity than that of the other UV irradiation units, thus curing the undercoat liquid and images on the recording medium P formed by various heads, including an image recorded by the recording head 48K.

A color image is thus formed on the recording medium P.

The recording medium P having a color image formed thereon is further transported by the transport roll 32 and transport roll pair 34 or the supply roll 30 and recovery roll 36, and taken up by the recovery roll 36.

The inkjet recording system 10 thus forms an image on the recording medium P.

Furthermore, forming an undercoat layer on the recording medium P enables ink composition liquid droplets that have landed on the recording medium to sink into the recording medium and can prevent the image from spreading, and a high quality image can be formed. Moreover, it is also possible to use a recording medium that has low adhesion to an ink composition liquid droplet, that is, that repels a landed ink composition liquid droplet, and an image can be recorded on various recording media. By coating the recording medium P with an undercoat liquid by using the coating roll 60 and rotating the coating roll 60 in the opposite direction to the transport direction of the recording medium P, it is possible to prevent disturbance of the surface of the undercoat liquid applied on the recording medium P when the coating roll 60 departs from the recording medium P after the recording medium P is coated with the undercoat liquid by the coating roll 60, and an undercoat layer U having an improved surface state can be formed on the recording medium P.

Furthermore, as in the present embodiment, by semi-curing the undercoat layer by means of the undercoat liquid semi-curing section, even if ink composition liquid droplets land on the recording medium while partially overlapping each other, due to interaction between the undercoat liquid and the ink composition liquid droplets it is possible to suppress coalescence of these adjacent ink composition liquid droplets.

That is, by forming a layer of a semi-cured undercoat liquid on the recording medium, when ink composition liquid droplets discharged from a recording head land in the vicinity of each other on the recording medium, for example, when single color ink composition liquid droplets land on the recording medium while partially overlapping each other, or when different color ink composition liquid droplets land on the recording medium while partially overlapping each other, it is possible to prevent the ink composition liquid droplets from moving.

It is thereby possible to prevent effectively spreading of an image, nonuniformity in line width of fine lines, etc. in an image, and the occurrence of uneven color on a colored surface, sharp lines with uniform width can be formed, and with regard to recording of an inkjet image with high fired droplet density such as reversed characters, a fine image such as fine lines can be recorded with good reproduction. That is, a higher quality image can be formed on the recording medium.

Furthermore, as in the present embodiment, by disposing a UV irradiation unit between the recording heads, and semi-curing ink composition liquid droplets that have been made to land on the recording medium by the recording heads, that is, an image, it is possible to prevent different color ink composition liquid droplets that have landed in the vicinity of each other from overlapping, or the ink composition liquid droplets that have landed from moving.

Furthermore, in the transport path of the recording medium, a UV irradiation unit corresponding to the recording head disposed on the most downstream side is used as the final curing UV irradiation unit, and made to radiate UV rays at higher intensity than that of the other UV irradiation units, and it is thereby possible to reliably cure an image formed on the recording medium.

Since the system can be made smaller, energy efficient, and inexpensive, in the present embodiment, the constitution of the final curing UV irradiation unit 54 is the same as that of the UV irradiation unit 52, but as the final curing UV irradiation unit 54 various types of UV light sources such as a metal halide lamp or a high-pressure mercury lamp may be used.

The final curing UV irradiation unit 54 also preferably employs a metal halide lamp or a high-pressure mercury lamp. That is, the inkjet recording system is also preferably constituted by using as a UV irradiation unit for semi-curing an undercoat liquid and/or an ink a UV irradiation unit equipped with the fluorescent lamp 80 and using as the final curing UV irradiation unit 54 a metal halide lamp, a high-pressure mercury lamp, etc.

Although the system is increased in size by using as the final curing UV irradiation unit 54 a metal halide lamp, a high-pressure mercury lamp, etc., the undercoat liquid and ink on the recording medium can be irradiated with more intense light, and the undercoat liquid and ink can be completely cured more reliably.

Furthermore, since nozzle clogging of the recording head can be prevented, a printed material can be produced at high speed, semi-curing can be carried out suitably, and the system can be made smaller, energy efficient, and inexpensive, it is preferable to use a UV irradiation unit equipped with the fluorescent lamp 80 for all of the UV irradiation units for semi-curing an undercoat liquid and/or an ink, but the present invention is not limited thereto, and although the above-mentioned effects are reduced, the constitution may be such that at least one thereof is a UV irradiation unit equipped with the fluorescent lamp 80, and the other UV irradiation units are formed from a metal halide lamp, a high-pressure mercury lamp, etc.

The fluorescent lamp 80 is preferably disposed at a position such that the shortest distance h between the recording medium P and the radiation face of the fluorescent lamp 80 is at least 0.5 mm but no greater than 1.5 mm. By disposing the fluorescent lamp 80 at a position that satisfies the above-mentioned range, the recording medium P can be irradiated with light efficiently.

Furthermore, the housing 82 is preferably disposed at a position such that the shortest distance H between the recording medium P and the housing 82 is H=h when the above h satisfies 0.5 mm≦h<1.0 mm, and H=1.0 mm when the above h satisfies 1.0 mm≦h.

By disposing the housing 82 at a position that satisfies the above-mentioned ranges, it becomes possible to suppress the amount of light that is emitted from the fluorescent lamp 80 and irradiates sections other than the recording medium P.

Furthermore, the UV irradiation unit preferably emits UV rays between a few hundred milliseconds and 5 seconds after an ink composition liquid droplet has landed on the recording medium from the recording head, thus semi-curing the ink composition liquid droplet that has landed on the recording medium.

By semi-curing the ink composition liquid droplet between a few hundred milliseconds and 5 seconds after the ink composition liquid droplet has landed, it is possible to prevent the shape of the ink composition liquid droplet on the recording medium from collapsing, thus enabling a high quality image to be formed.

Furthermore, the undercoat liquid preferably has a viscosity of at least 10 mPa·s but no greater than 500 mPa·s, and more preferably at least 50 mPa·s but no greater than 300 mPa·s.

By making the viscosity of the undercoat liquid at least 10 mPa·s, and preferably at least 50 mPa·s, as described above it becomes possible to coat with an undercoat liquid a recording medium that is difficult for a liquid to adhere to.

Furthermore, by making the viscosity of the undercoat liquid no greater than 500 mPa·s, and preferably no greater than 300 mPa·s, it becomes possible to reliably reduce the surface roughness of the undercoat layer formed on the recording medium P.

The inkjet recording system 10 is explained in more detail below by reference to one example.

A light irradiation device having an aperture type hot cathode fluorescent tube with a getter mounted in the vicinity of an electrode of a fluorescent lamp 80 has a constitution such that a cooling mechanism (fan) 84 is disposed in the vicinity of and above an electrode 88 at each of opposite ends of the fluorescent lamp 80, and heat generated by the electrode 88 is dissipated by rotating the cooling mechanism (fan) 84 at an appropriate rotational speed.

As the fluorescent lamp 80, a linear tube having a diameter of 32 mm is used as a bulb, and a phosphor emitting light having a central wavelength of 365 nm is used in a phosphor film.

The fluorescent lamp 80 is disposed at a position so that the shortest distance h between the radiation face of the fluorescent lamp and a recording medium P is 1 mm, and a housing 82 is disposed at a position so that the shortest distance H between the housing 82 and the recording medium P is 1 mm. Furthermore, as a recording head a 600 dpi inkjet head is used.

The above-mentioned constitution of the fluorescent lamp 80 is explained in further detail as follows.
Glass bulb: soda-lime glass (having no absorption in the UV region)
Protective film: alumina
Phosphor: SrB₄O₇, Eu²⁺
Encapsulated gas: argon
Getter: Zr—Co-Rare Earth Elements (SAES Getters, St787)

Mounting of the getter is carried out by cutting out part of an anode and welding to the anode a ribbon-shaped getter.

With regard to a method for mounting a getter, other than the above, there are a method in which a ribbon-shaped getter is superimposed on an outer face of at least part of an anode and welded, a method in which a ribbon-shaped getter is welded to a highly heat resistant metal component without being in contact with the cathode or the anode and mounted at a position separated from the electrode by 0.1 to 30 mm, etc. In short, it can be mounted at a position within 30 mm from the electrode in order to obtain heat required for activation.

Furthermore, as the type of fluorescent lamp 80, it is also possible to use an aperture type hot cathode fluorescent tube shown in FIGS. 2(A) and (B) that does not have the perfectly circular phosphor film 92 above and has a reflection film having a transmittance of no greater than 10% between the protective film 90 and the phosphor film 92, the reflection film, which is rectangular, having a major side parallel to the lamp axis, and an aperture face without a coating of the phosphor film 92. In this case, the irradiation efficiency in a specific direction corresponding to the aperture face is improved.

In the fluorescent lamp 80 shown in FIGS. 2(A) and (B), as shown in the figure by reference number 88+89, a ribbon-shaped getter 89 is welded to the anode 88b.

Furthermore, the constitution is such that heat generated by the electrode 88 is dissipated by disposing cooling mechanisms (fans) 84 in the vicinity of and above the electrodes 88 at opposite ends and rotating them at an appropriate rotational speed. Since it is possible to suppress an increase in the temperature of the electrode 88 by dissipating heat generated by the electrode 88 by means of a cooling mechanism such as the cooling mechanism (fan) 84, it becomes possible to suppress the temperature of the electrode 88 to within a range in which the getter 89 and a member mounted thereon do not vaporize, thereby controlling the occurrence of the problem of vaporized material adhering to the inner face, etc. of the bulb 86 and blackening the inner face of the bulb 86.

By disposing the getter cooling fan 84 in the vicinity of the electrode 88 equipped with the getter 89, any decrease in the emission intensity of the fluorescent lamp 80 due to vaporization of the getter or a retaining member for adsorbing/retaining same can be almost completely prevented.

Other than the above-mentioned method in which the getter cooling fan 84 is disposed in the vicinity of the electrode 88, the effect in preventing degradation in emission intensity of the fluorescent lamp 80 by disposing getter cooling means in the vicinity of the electrode 88 equipped with the getter 89 can also be obtained in substantially the same manner by a method in which a getter cooling heat pipe 95 is disposed in the vicinity of the electrode 88 equipped with the getter 89 as shown in FIG. 3 above.

The cooling mechanism that can be used in the present invention is not particularly limited, and a known mechanism may be used.

The inkjet recording method of the present invention and the inkjet recording system of the present invention are characterized, as described above, by the use of an aperture type hot cathode fluorescent tube having a getter in the interior as a UV light source in UV irradiation means and by the use of an ink composition comprising a vinyl ether compound, an oxirane compound and/or oxetane compound, a cationic photopolymerization initiator, and a colorant.

The ink composition that is suitably used in the present invention is explained in detail below.

The ink composition that can be used in the present invention comprises a vinyl ether compound, an oxirane compound and/or oxetane compound, a cationic photopolymerization initiator, and a colorant. It may further comprise as desired a UV absorber, a sensitizer, an antioxidant, an antifading agent, a conductive salt, a solvent, a polymer compound, a surfactant, etc.

Furthermore, the ink composition that can be used in the present invention is an ink composition that can be cured by UV rays and is an oil-based ink composition.

Moreover, the ink composition that can be used in the present invention may suitably be used as an inkjet recording ink composition.

The components used in the ink composition are explained below in sequence.

### Vinyl Ether Compound

The ink composition that can be used in the present invention comprises a vinyl ether compound.

By combining a vinyl ether compound, low viscosity required for the inkjet recording ink composition can be realized. The curing speed can also be improved.

The ink composition that can be used in the present invention may employ only one type of vinyl ether compound or two or more types thereof in combination.

Examples of the vinyl ether compounds include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl vinyl ether, dodecyl vinyl ether, ethylene glycol monovinyl ether, diethylene glycol monovinyl ether, triethylene glycol monovinyl ether, octadecyl vinyl ether, hydroxyethyl monovinyl ether, and hydroxynonyl monovinyl ether.

Among these vinyl ether compounds, the di- or tri-vinyl ether compounds are preferable from the viewpoint of curability, adhesion to a recording medium, surface hardness of the image, and the divinyl ether compounds are particularly preferable.

The vinyl ether compound preferably has a cyclic skeleton from the viewpoint of polymerizability and curing hardness, and specific examples thereof include a compound represented by Formula (1) below.

R¹³—R¹⁴—(R¹³)p (1)

In Formula (1) above, R¹³ is selected from a vinyl ether group, a vinyl ether skeleton-containing group, an alkoxy group, a hydroxy group-substituted group, and a hydroxy group, and at least one thereof is a vinyl ether group or a vinyl ether skeleton-containing group. R¹⁴ is a (p+1)-valent group having a substituted or unsubstituted cyclic skeleton, and p is a positive integer including 0. When R¹⁴ is a cyclohexane ring skeleton and p is 0, from the viewpoint of volatility, an oxygen-containing structure is preferable. Specific examples thereof include a structure in which at least one carbon atom in the ring has a ketone structure, a structure in which it is replaced by an oxygen atom, and a structure having an oxygen-containing substituent.

From the viewpoint of curability, it is desirable for the number of vinyl ether groups introduced into the above-mentioned molecular skeleton to be large, and although it is not particularly limited it is preferably not more than 2 or 3 valent in order to impart resolubility to the ink layer after curing.

Examples of the (p+1)-valent organic group R¹⁴ include a substituted or unsubstituted aromatic ring such as, for example, a benzene ring, naphthalene ring, or biphenyl ring-containing (p+1)-valent group. Alternatively, a derivatized (p+1)-valent group of an alicyclic skeleton such as, for example, a cycloalkane skeleton, a norbornane skeleton, an adamantane skeleton, a tricyclodecane skeleton, a tetracyclododecane skeleton, a terpenoid skeleton, or a cholesterol skeleton may also be used. It is preferable for such an alicyclic skeleton to have a bridged structure since the hardness of a cured material increases. From the viewpoint of volatility, an oxygen-containing structure is preferable. Specific examples thereof include a structure in which some carbons of the ring have a ketone structure, a structure in which they are replaced by an oxygen atom, or a structure having an oxygen-containing substituent.

The compound represented by Formula (1) usually has a viscosity of on the order of 1 to 30 mPa·s. The use of such a compound is therefore effective in sufficiently reducing the viscosity of the inkjet ink.

Among the compounds represented by Formula (1), it is preferable for at least one vinyl ether group to be directly bonded to the ring since cationic curability is excellent and even when a pigment is contained at the same time curability is excellent.

It is preferable for the cyclic compound to contain an aromatic skeleton since hardness is imparted to a cured material and the solubility of a photosensitizing agent, etc. can be improved.

Specific examples of such a vinyl ether compound include a compound in which a hydroxy group of the following alcohol compound is replaced with a vinyl ether or 1-propenyl ether.

Specific examples of the vinyl ether compound are represented by the chemical formulae below.

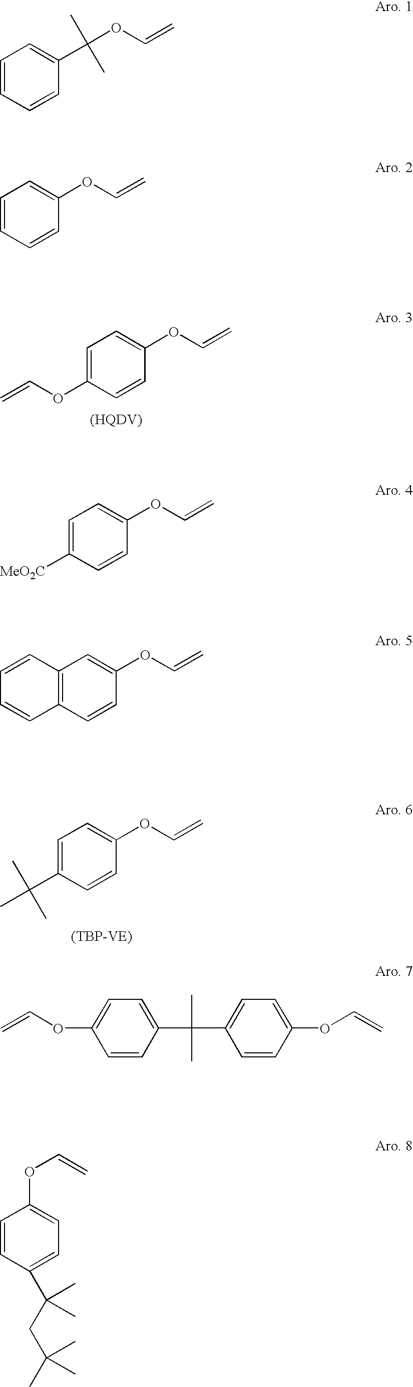

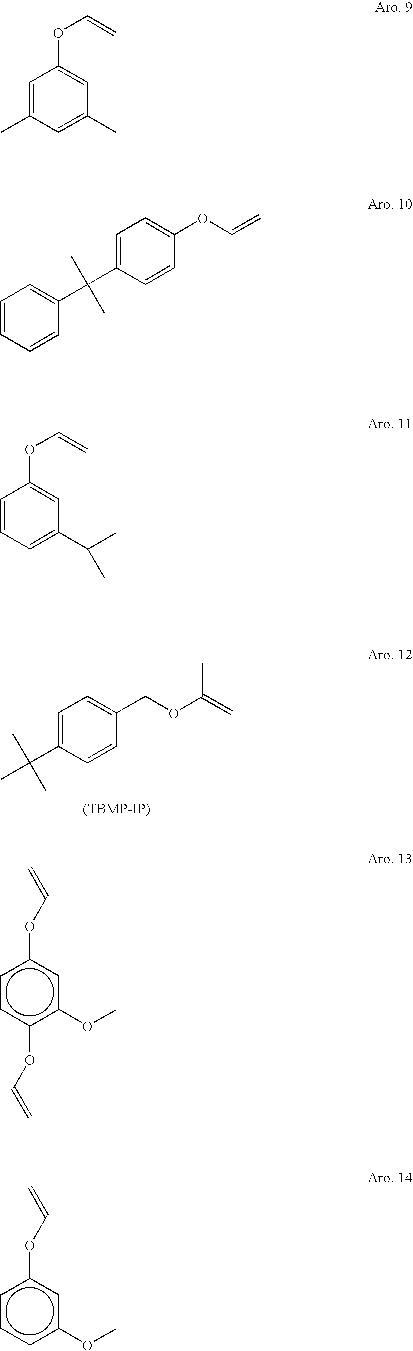

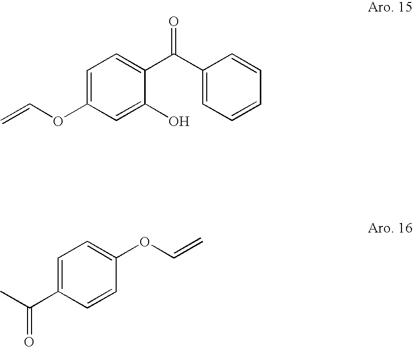

From the viewpoint of safety, the cyclic compound is preferably a vinyl ether compound having an alicyclic skeleton rather than an aromatic vinyl ether.

As such a vinyl ether compound having an alicyclic skeleton, a monocycle in which the cyclic skeleton is formed from a 4- to 6-membered ring or an alicyclic skeleton having a structure in which the monocycles are bridged is preferable. Examples thereof include compounds formed by replacing a hydroxy group of the following alicyclic alcohol compounds with vinyl ether or 1-propenyl ether.

Examples of the alicyclic alcohol compounds include cyclopentanemono(di)ol, cyclopentanemono(di)methanol, cyclohexane(di)ol, cyclohexanemono(di)methanol, norbornanemono(di)ol, norbornanemonoolmonomethanol, norbornanemono(di)methanol, tricyclodecanemono(di)ol, tricyclodecanemono(di)methanol, and adamantanemono(di)ol.

More specifically, the above alicyclic skeleton has a structure represented by Formula (VE1-a) or (VE1-b) below.

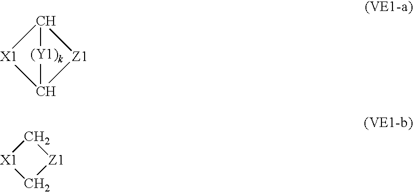

(in Formula (VE1-a) and Formula (VE1-b), X1 and Z1 independently denote alkylene group having 1 to 5 carbon atoms, Y1 denotes alkylene group having 1 or 2 carbon atoms, and k is a integer 0 or 1.)

More specific examples of the vinyl ether compound are listed below.

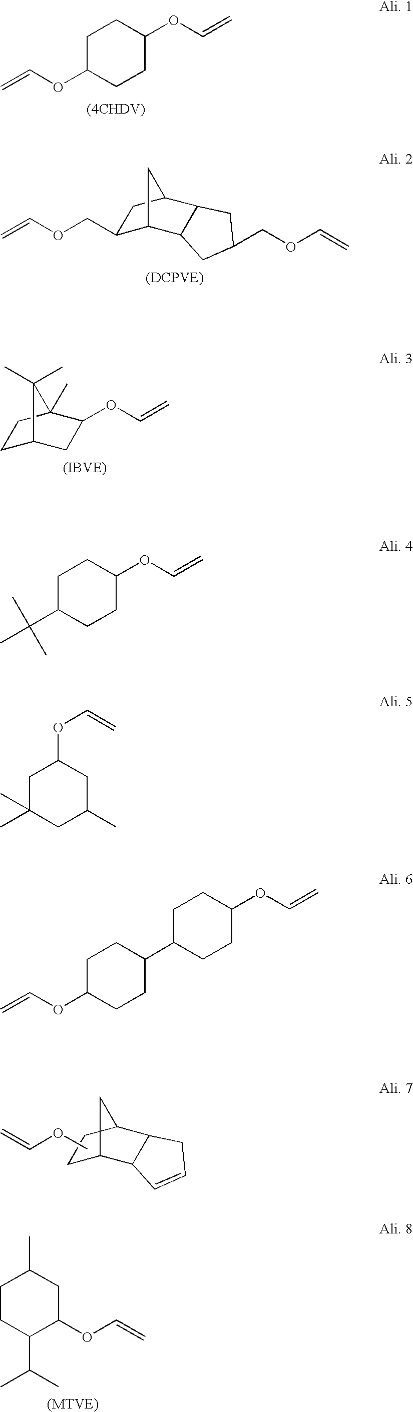

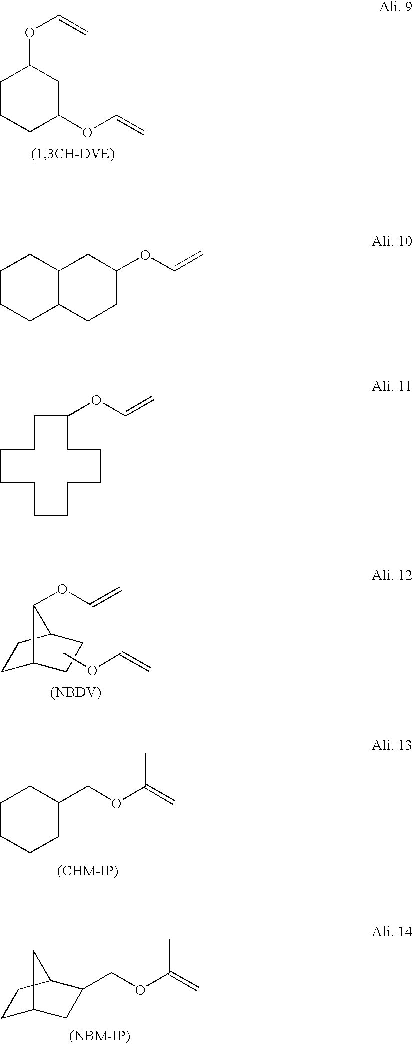

Among the above compounds, an alicyclic skeleton having a bridged structure is preferable since the hardness of a cured material increases. Furthermore, RAPI-CURE CHVE: cyclohexanedimethanol divinyl ether and RAPI-CURE CHMVE: cyclohexanedimethanol monovinyl ether manufactured by ISP Japan Ltd. are generally known, but since in such compounds vinyl ether is not directly bonded to a cyclic skeleton, from the viewpoint of acid polymerizability the performance tends to deteriorate.

Among the compounds having an alicyclic skeleton, from the viewpoint of volatility and pigment dispersibility, an oxygen-containing structure such as a structure in which some carbons of the ring are replaced by an oxygen atom or a structure having an oxygen-containing substituent is preferable.

Examples of a vinyl ether compound having a cyclic structure with an oxygen-containing substituent include compounds formed by replacing at least one hydroxy group of an alcohol compound having a monocycle in which the cyclic skeleton is formed from a 4- to 6-membered ring or an alicyclic skeleton having a structure in which the monocycles are bridged, by an ether or ester such as a methoxy group, a methoxyethoxy group, an alkoxy group, an acetoxy group, or an alkyl ester group, and replacing the remaining groups by vinyl ether or 1-propenyl ether.

Examples of the alcohol compound include cyclopentanediol, cyclohexanedi(tri)ol, cyclohexanedi(tri)methanol, norbornanedi(tri)ol, norbornanemono(di)olmono(di)methanol, norbornanedi(tri)methanol, tricyclodecanedi(tri)ol, tricyclodecanedi(tri)methanol, and adamantanedi(tri)ol.

More specifically, a vinyl ether compound having an oxygen-containing substituent represented by the chemical formulae below is the most preferable.

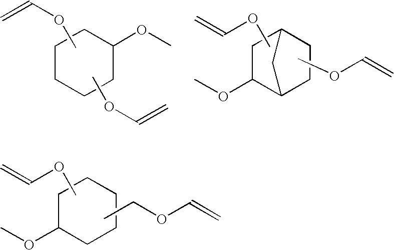

On the other hand, when an oxygen atom is contained within the alicyclic skeleton, the viscosity stability further improves, and this is preferable. Examples of such a compound includes compounds represented by Formula (VE2-a) or (VE2-a) below.

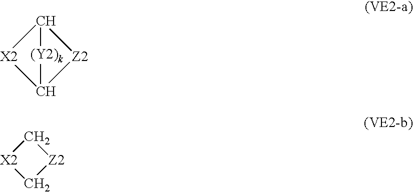

(in Formula (VE2-a) and Formula (VE2-b), any one of X1, Y2, and Z2 contains at least one oxygen atom, X2 and Z2 independently denote an alkylene group having 1 to 5 carbon atoms or a divalent organic group having an oxygen atom as an ether bond, Y2 denotes an oxygen atom, an alkylene group having 1 or 2 carbon atoms, or a divalent organic group including an oxygen atom as an ether bond and k is a integer 0 or 1.)

With regard to such a compound, in order to exhibit the safety and excellent curing performance of an alicyclic skeleton, in order to exhibit the high surface tension of a cyclic hydrocarbon skeleton containing an oxygen atom as a ring member atom to thus show high solubility and dispersibility and, furthermore, in order to reduce the phenomenon of ink being repelled by a comparatively hydrophilic printing medium, a vinyl ether compound having all of these properties is most preferably used.

As a vinyl ether compound having an alicyclic skeleton of the above structure, a cyclic ether skeleton-containing compound in which the cyclic skeleton is a 4- to 6-membered ring is preferable.

Examples thereof include a compound formed by replacing a hydroxy group of the alcohol compounds below by vinyl ether or 1-propenyl ether. Specific examples thereof include a substituted or unsubstituted oxetanemonool, a substituted or unsubstituted oxetanemonomethanol, oxapentanemono(di)ol, or oxacyclohexanemono(di)ol, isosorbitol, mannitol, oxanorbornanemono(di)ol, oxanorbornanemonoolmonomethanol, oxanorbornanemono(di)methanol, oxatricyclodecanemono(di)ol, oxaadamantanemono(di)ol, and dioxolane methanol.

Among such compounds, with regard to the structure of a cyclic skeleton moiety represented by Formula (VE2-a) or (VE2-b) above, the ratio of the number of oxygen atoms to the number of carbon atoms (number of oxygen atoms/number of carbon atoms) preferably exceeds 0.08. In accordance with the use of such a vinyl ether compound, an ink composition that exhibits characteristic physical properties related to polarity, such as solubility or printing medium wettability, is obtained. The (number of oxygen atoms/number of carbon atoms) ratio is preferably at least 0.15, and more preferably at least 0.25.

Specific examples of the vinyl ether compound include CAS No. 22214-12-6 and CAS No. 20191-85-9. As for these compounds, a compound having a distorted cyclic ether structure such as an oxetane ring or a hydrofuran ring is preferable since the reactivity improves. In particular, a hydrofuran ring is more preferable from the viewpoint of volatility. Furthermore, a vinyl ether compound in which such a cyclic structure is a bridged structure is particularly preferable since the curing hardness increases. More specifically, the vinyl ethers shown below are most preferable.

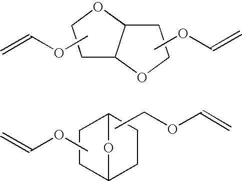

The above-mentioned series of vinyl ether compounds may suitably be synthesized by a method described in, for example, J. Chem. Soc., 1965 (2), 1560-1561 or J. Am. Chem. Soc., Vol. 124, No. 8, 1590-1591 (2002).

When such a method is used, a corresponding aromatic alcohol or alicyclic alcohol compound is used as a starting material, and it is reacted with an acetate ester of a vinyl alcohol or a 1-propenyl alcohol in the presence of a catalyst such as an iridium halide. This enables a target vinyl ether or 1-propenyl ether compound to be easily obtained.

For example, menthol vinyl ether (MTVE) may be obtained by stirring and heating menthol and vinyl acetate with an iridium compound as a catalyst in a sodium carbonate toluene liquid mixture under an argon atmosphere.

Such a synthetic method can suitably be used for any compound cited as an example in the present application.

In the present invention, the content of the vinyl ether compound in the ink composition is preferably 1 to 84 wt %, more preferably 3 to 84 wt %, and yet more preferably 7 to 65 wt %. When in the above-mentioned range, dischargeability and curability of the ink composition are excellent.

When the content of the vinyl ether compound in the ink composition is at least 1 wt %, the ink composition has excellent dischargeability, and nozzle clogging does not occur. When the content of the vinyl ether compound in the ink composition is not greater than 84 wt %, the ink composition has excellent sensitivity.

Oxirane compound

Examples of the epoxy compounds include aromatic epoxides, alicyclic epoxides, and aliphatic epoxides.

Examples of the aromatic epoxide include di- or polyglycidyl ethers produced by a reaction between epichlorohydrin and a polyhydric phenol having at least one aromatic nucleus or an alkylene oxide adduct thereof; specific examples include di- or polyglycidyl ethers of bisphenol A or an alkylene oxide adduct thereof, di- or polyglycidyl ethers of hydrogenated bisphenol A or an alkylene oxide adduct thereof, and novolac type epoxy resins. Examples of the alkylene oxide above include ethylene oxide and propylene oxide.

Examples of the alicyclic epoxides include cyclohexene oxide- and cyclopentene oxide-containing compounds obtained by epoxidizing a compound having at least one cycloalkene ring such as a cyclohexene ring or a cyclopentene ring with an appropriate oxidizing agent such as hydrogen peroxide or a peracid.

Examples of the aliphatic epoxides include di- or polyglycidyl ethers of an aliphatic polyhydric alcohol or an alkylene oxide adduct thereof. Representative examples thereof include diglycidyl ethers of an alkylene glycol such as the diglycidyl ether of ethylene glycol, the diglycidyl ether of propylene glycol, and the diglycidyl ether of 1,6-hexanediol, polyglycidyl ethers of a polyhydric alcohol such as the di- or triglycidyl ether of glycerol or an alkylene oxide adduct thereof, and diglycidyl ethers of a polyalkylene glycol such as the diglycidyl ether of polyethylene glycol or an alkylene oxide adduct thereof and the diglycidyl ether of polypropylene glycol or an alkylene oxide adduct thereof. Examples of the alkylene oxide above include ethylene oxide and propylene oxide.

The epoxy compound may be either monofunctional or polyfunctional.

Examples of monofunctional epoxy compounds that can be used in the present invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinylcyclohexene oxide.

Furthermore, examples of polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexenecarboxylate, 2-(3,4-epoxycyclohexyl-5,5-spiro-3,4-epoxy)cyclohexane-meta-dioxane, bis(3,4-epoxycyclohexylmethyl) adipate, vinylcyclohexene dioxide, 4-vinylepoxycyclohexane, bis(3,4-epoxy-6-methylcyclohexylmethyl) adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, di(3,4-epoxycyclohexylmethyl) ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, 1,2,5,6-diepoxycyclooctane, and 1,2:8,9-diepoxylimonene. Among these polyfunctional epoxy compounds, 3,4-epoxycyclohexenylmethyl-3′,4′-epoxycyclohexenecarboxylate is preferable.

Among these epoxy compounds, the aromatic epoxides and the alicyclic epoxides are preferable from the viewpoint of excellent curing speed, and the alicyclic epoxides are particularly preferable.

As an oxirane compound that can be used in the present invention, an epoxy compound represented by Formula (ME-1) or (ME-2) is preferable.

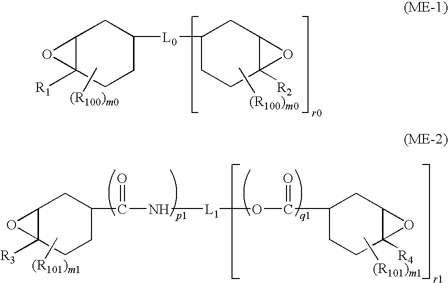

In the formulae above, R₁, R₂, R₃, R₄, R₁₀₀, and R₁₀₁ independently denote a substituent.

Examples of the substituent include a halogen atom (e.g. a chlorine atom, a bromine atom, a fluorine atom, etc.), an alkyl group having 1 to 6 carbon atoms (e.g. a methyl group, an ethyl group, a propyl group, an isopropyl group, a butyl group, etc.), an alkoxy group having 1 to 6 carbon atoms (e.g. a methoxy group, an ethoxy group, a n-propoxy group, an isopropoxy group, a n-butoxy group, a tert-butoxy group, etc.), an acyl group (e.g. an acetyl group, a propionyl group, a trifluoroacetyl group, etc.), an acyloxy group (e.g. an acetoxy group, a propionyloxy group, a trifluoroacetoxy group, etc.), and an alkoxycarbonyl group (a methoxycarbonyl group, an ethoxycarbonyl group, a tert-butoxycarbonyl group, etc.).

Preferred substituents are an alkyl group, an alkoxy group, and an alkoxycarbonyl group.

m0 and m1 denote an integer of 0 to 2, and are preferably 0 or 1.

L₀ denotes a single bond or an (r0+1)-valent linking group having 1 to 15 carbon atoms and containing an oxygen atom and a nitrogen atom in the main chain, and L₁ denotes a single bond or an (r1+1)-valent linking group having 1 to 15 carbon atoms and containing an oxygen atom or a sulfur atom in the main chain.

Examples of the divalent linking group having 1 to 15 carbon atoms and containing an oxygen atom or a sulfur atom in the main chain include the groups listed below and groups formed by multiply combining these groups with an —O—, —S—, —CO—, or —CS— group.

A methylene group [—CH₂—], an ethylidene group [>CHCH₃], an isopropylidene group [>C(CH₃)₂], a 1,2-ethylene group [—CH₂CH₂—], a 1,2-propanediyl group [—CH(CH₃)CH₂—], a 1,3-propanediyl group [—CH₂CH₂CH₂—], a 2,2-dimethyl-1,3-propanediyl group [—CH₂C(CH₃)₂CH₂—], a 2,2-dimethoxy-1,3-propanediyl group [—CH₂C(OCH₃)₂CH₂—], a 2,2-dimethoxymethyl-1,3-propanediyl group [—CHC(CHOCH₃)₂CH₂—], a 1-methyl-1,3-propanediyl group [—CH(CH₃)CH₂CH₂—], a 1,4-butanediyl group [—CH₂CH₂CH₂CH₂—], a 1,5-pentanediyl group [—CH₂CH₂CH₂CH₂CH₂—],

an oxydiethylene group [—CH₂CH₂OCH₂CH₂—], a thiodiethylene group [—CH₂CH₂SCH₂CH₂], a 3-oxothiodiethylene group [—CH₂CH₂SOCH₂CH₂—], a 3,3-dioxothiodiethylene group [—CH₂CH₂SO₂CH₂CH₂—], a 1,4-dimethyl-3-oxa-1,5-pentanediyl group [—CH(CH₃)CH₂OCH(CH₃)CH₂—], a 3-oxopentanediyl group [—CH₂CH₂COCH₂CH₂—], a 1,5-dioxo-3-oxapentanediyl group [—COCH₂OCH₂CO—], a 4-oxa-1,7-heptanediyl group [CH₂CH₂CH₂OCH₂CH₂CH₂—], a 3,6-dioxa-1,8-octanediyl group [—CH₂CH₂OCH₂CH₂OCH₂CH₂—], a 1,4,7-trimethyl-3,6-dioxa-1,8-octanediyl group [—CH(CH₃)CH₂OCH(CH₃)CH₂OCH(CH₃)CH₂—], a 5,5-dimethyl-3,7-dioxa-1,9-nonanediyl group [—CH₂CH₂OCH₂C(CH₃)₂CH₂OCH₂CH₂—], a 5,5-dimethoxy-3,7-dioxa-1,9-nonanediyl group [—CH₂CH₂OCH₂C(OCH₃)₂CH₂OCH₂CH₂—], a 5,5-dimethoxymethyl-3,7-dioxa-1,9-nonanediyl group [—CH₂CH₂OCH₂C(CH₂OCH₃)₂CH₂OCH₂CH₂—], a 4,7-dioxo-3,8-dioxa-1,10-decanediyl group [—CH₂CH₂O-COCH₂CH₂CO-OCH₂CH₂—], a 3,8-dioxo-4,7-dioxa-1,10-decanediyl group [—CH₂CH₂CO-OCH₂CH₂O-COCH₂CH₂—],

a 1,3-cyclopentanediyl group [-1,3-C₅H₈—], a 1,2-cyclohexanediyl group [-1,2-C₆H₁₀—], a 1,3-cyclohexanediyl group [-1,3-C₆H₁₀—], a 1,4-cyclohexanediyl group [-1,4-C₆H₁₀—], a 2,5-tetrahydrofurandiyl group [-2,5-C₄H₆O—], a p-phenylene group [-p-C₆H₄—], a m-phenylene group [-m-C₆H₄—], an α,α′-o-xylylene group [-o-CH₂—C₆H₄—CH₂—], an α,α′-m-xylylene group [-m-CH₂—C₆H₄—CH₂—], an α,α′-p-xylylene group [-p-CH₂—C₆H₄—CH₂—], a furan-2,5-diylbismethylene group [2,5-CH₂—C₄H₂O—CH₂—], a thiophene-2,5-diylbismethylene group [2,5-CH₂—C₄H₂S—CH₂—], an isopropylidenebis(p-phenylene) group [-p-C₆H₄—C(CH₃)₂-p-C₆H₄—].

Examples of the tri- or higher-valent linking group include groups formed by removing a required number of hydrogen atoms at any site of the above-mentioned divalent linking groups and groups formed by multiply combining these groups with an —O—, —S—, —CO—, or —CS— group.

L₀ and L₁ may have a substituent.

Examples of the substituent include a halogen atom (e.g. a chlorine atom, a bromine atom, a fluorine atom, etc.), an alkyl group having 1 to 6 carbon atoms (e.g. a methyl group, an ethyl group, a propyl group, an isopropyl group, a butyl group, etc.), an alkoxy group having 1 to 6 carbon atoms (e.g. a methoxy group, an ethoxy group, a n-propoxy group, an isopropoxy group, a n-butoxy group, a tert-butoxy group, etc.), an acyl group (e.g. an acetyl group, a propionyl group, a trifluoroacetyl group, etc.), an acyloxy group (e.g. an acetoxy group, a propionyloxy group, a trifluoroacetoxy group, etc.), and an alkoxycarbonyl group (a methoxycarbonyl group, an ethoxycarbonyl group, a tert-butoxycarbonyl group, etc.).

Preferred substituents are an alkyl group, an alkoxy group, and an alkoxycarbonyl group.

L₀ is preferably a divalent linking group having 1 to 8 carbon atoms and containing an oxygen atom and a nitrogen atom in the main chain, and more preferably one having an amide bond in the main chain.

L₁ is preferably a divalent linking group having 1 to 8 carbon atoms which may contain an oxygen atom or a sulfur atom in the main chain, and more preferably a divalent linking group having 1 to 5 carbon atoms and containing only carbons in the main chain.

p1 denotes 1 or 2, q1 denotes an integer of 0 to 2, and p1+q1 is preferably at least 1.

The ink composition that can be used in the present invention may use only one type of oxirane compound or two or more types thereof in combination.

In the present invention, the ink composition preferably comprises 5 to 80 wt % of an oxirane compound in the ink composition, and more preferably 17 to 60 wt %. When in the above-mentioned range, the ink has excellent curability.

### Oxetane Compound

In the present invention, an oxetane compound may suitably be used. For example, when high speed printing such as a few tens of meters per minute is required, or when solvent resistance is required, it is preferable for an oxetane to be combined. When an oxetane compound is used as a main solvent for a conventional inkjet ink, the viscosity is usually increased greatly, and it is difficult to adjust the viscosity with another solvent. However, when used in combination with a vinyl ether compound, since this vinyl ether compound has a very low viscosity, it is possible to easily make an ink.

The oxetane compound in the present invention means a compound having at least one oxetane ring, and may be selected freely from known oxetane compounds such as those described in JP-A-2001-220526, JP-A-2001-310937, and JP-A-2003-341217.

As the compound having an oxetane ring that can be used in the ink composition in the present invention, a compound having 1 to 4 oxetane rings in the structure is preferable. In accordance with use of such a compound, it becomes easy to maintain the viscosity of the ink composition in a range that gives good handling properties and, furthermore, the cured ink can be given high adhesion to the recording medium.

Such compounds having an oxetane ring are described in detail in paragraph Nos. (0021) to (0084) of JP-A-2003-341217 above, and the compounds described here may be suitably used in the present invention.

Among the oxetane compounds that can be used in the present invention, from the viewpoint of ink composition viscosity and tackiness, it is preferable to use a compound having one oxetane ring.

The ink composition that can be used in the present invention may comprise only one type of oxetane compound or two or more types thereof in combination.

In the present invention, the content of the oxetane compound in the ink composition is suitably in the range of 1 to 50 wt % relative to the total solids content of the composition, preferably 5 to 20 wt %. In the above mentioned range, the curability of an ink composition and the flexibility of a cured ink composition are excellent.

### Ratio by Weight of Vinyl Ether Compound to Total Amount of Oxirane Compound and Oxetane Compound

The ratio by weight of the vinyl ether compound to the total amount of the oxirane compound and oxetane compound contained in the ink composition is preferably vinyl ether compound:oxirane compound and oxetane compound=1:99 to 90:10, and more preferably vinyl ether compound:oxirane compound and oxetane compound=8:92 to 75:25. When in the above-mentioned range, the ink has excellent dischargeability and curability.

When the ink composition contains only either one of an oxirane compound or an oxetane compound, the weight of said either one compound contained in the ink composition is used as the total amount of the oxirane compound and oxetane compound.

### Cationic Photopolymerization Initiator

The ink composition that can be used in the present invention comprises a cationic photopolymerization initiator.

The cationic photopolymerization initiator is not particularly limited; a known compound may be used, but a compound that generates an acid by irradiation with UV rays (hereinafter, also called a ‘photo-acid generator’) is preferable.

Examples of the photo-acid generator include an onium salt that generates an acid by being decomposed by irradiation with UV rays, such as a diazonium salt, an ammonium salt, a phosphonium salt, an iodonium salt, a sulfonium salt, a selenonium salt, or an arsonium salt, an organic halogen compound, an organometallic/organic halide, a photo-acid generator having an o-nitrobenzyl-based protecting group, a compound such as an iminosulfonate that generates a sulfonic acid by being photodecomposed, a disulfone compound, diazoketosulfone, and a diazodisulfone compound.

Furthermore, oxazole derivatives and s-triazine derivatives described in Paragraph Nos. (0029) to (0030) of JP-A-2002-122994 may suitably be used as a photo-acid generator. Onium salt compounds and sulfonate-based compounds cited as examples in Paragraph Nos. (0037) to (0063) of JP-A-2002-122994 may also be suitably used as a photo-acid generator in the present invention.

The photo-acid generator may be used singly or in a combination of two or more types.

The content of the photo-acid generator in the ink composition is preferably 0.1 to 20 wt % on the basis of the total solids content of the ink composition, more preferably 3 to 15 wt %, and yet more preferably 6 to 14 wt

### Colorant

By adding a colorant to the ink composition in the present invention, a visible image may be formed.

The colorant that can be used in the present invention is not particularly limited, and various types of known coloring materials (pigments, dyes) may be selected as appropriate according to the intended application. For example, when forming an image having excellent weather resistance, a pigment is preferable. As a dye, either a water-soluble dye or an oil-soluble dye may be used, and an oil-soluble dye is preferable.

### Pigment

The pigment is not particularly limited, and it is possible to use any generally commercially available organic pigment or inorganic pigment, a dispersion of a pigment in an insoluble resin, etc. as a dispersion medium, a pigment on the surface of which a resin has been grafted, etc. It is also possible to use resin particles colored with a dye, etc.

Examples of these pigments include pigments described in ‘Ganryo no Jiten’ (Dictionary of Pigments) Ed. by Seijirou Ito (2000), W. Herbst, K. Hunger ‘Industrial Organic Pigments’, JP-A-2002-12607, JP-A-2002-188025, JP-A-2003-26978, and JP-A-2003-342503.

Specific examples of the organic pigment and the inorganic pigment that can be used in the present invention include, as those exhibiting a yellow color, monoazo pigments such as CI Pigment Yellow 1 (Fast Yellow G, etc.) and CI Pigment Yellow 74, disazo pigments such as CI Pigment Yellow 12 (Disazo Yellow AAA, etc.) and CI Pigment Yellow 17, benzidine-free azo pigments such as CI Pigment Yellow 180, azo lake pigments such as CI Pigment Yellow 100 (Tartrazine Yellow Lake, etc.), condensed azo pigments such as CI Pigment Yellow 95 (Azo Condensation Yellow GR, etc.), acidic dye lake pigments such as CI Pigment Yellow 115 (Quinoline Yellow Lake, etc.), basic dye lake pigments such as CI Pigment Yellow 18 (Thioflavine Lake, etc.), anthraquinone pigments such as Flavanthrone Yellow (Y-24), isoindolinone pigments such as Isoindolinone Yellow 3RLT (Y-110), quinophthalone pigments such as Quinophthalone Yellow (Y-138), isoindoline pigments such as Isoindoline Yellow (Y-139), nitroso pigments such as CI Pigment Yellow 153 (Nickel Nitroso Yellow, etc.), and metal complex azomethine pigments such as CI Pigment Yellow 117 (Copper Azomethine Yellow, etc.).

Examples of pigments exhibiting a red or magenta color include monoazo pigments such as CI Pigment Red 3 (Toluidine Red, etc.), disazo pigments such as CI Pigment Red 38 (Pyrazolone Red B, etc.), azo lake pigments such as CI Pigment Red 53:1 (Lake Red C, etc.) and CI Pigment Red 57:1 (Brilliant Carmine 6B), condensed azo pigments such as CI Pigment Red 144 (Azo Condensation Red BR, etc.), acidic dye lake pigments such as CI Pigment Red 174 (Phloxine B Lake, etc.), basic dye lake pigments such as CI Pigment Red 81 (Rhodamine 6G′ Lake, etc.), anthraquinone pigments such as CI Pigment Red 177 (Dianthraquinonyl Red, etc.), thioindigo pigments such as CI Pigment Red 88 (Thioindigo Bordeaux, etc.), perinone pigments such as CI Pigment Red 194 (Perinone Red, etc.), perylene pigments such as CI Pigment Red 149 (Perylene Scarlet, etc.), quinacridone pigments such as CI Pigment violet 19 (unsubstituted quinachridone) and CI Pigment Red 122 (Quinacridone Magenta, etc.), isoindolinone pigments such as CI Pigment Red 180 (Isoindolinone Red 2BLT, etc.), and alizarin lake pigments such as CI Pigment Red 83 (Madder Lake, etc.).

Examples of pigments exhibiting a blue or cyan color include disazo pigments such as CI Pigment Blue 25 (Dianisidine Blue, etc.), phthalocyanine pigments such as CI Pigment Blue 15 (Phthalocyanine Blue, etc.) and CI Pigment Blue 15:3, acidic dye lake pigments such as CI Pigment Blue 24 (Peacock Blue Lake, etc.), basic dye lake pigments such as CI Pigment Blue 1 (Victoria Pure Blue BO Lake, etc.), anthraquinone pigments such as CI Pigment Blue 60 (Indanthrone Blue, etc.), and alkali blue pigments such as CI Pigment Blue 18 (Alkali Blue V-5:1).

Examples of pigments exhibiting a green color include phthalocyanine pigments such as CI Pigment Green 7 (Phthalocyanine Green) and CI Pigment Green 36 (Phthalocyanine Green), and azo metal complex pigments such as CI Pigment Green 8 (Nitroso Green).

Examples of pigments exhibiting an orange color include isoindoline pigments such as CI Pigment Orange 66 (Isoindoline Orange) and anthraquinone pigments such as CI Pigment Orange 51 (Dichloropyranthrone Orange).

Examples of pigments exhibiting a black color include carbon black, titanium black, and aniline black.

Specific examples of white pigments that can be used include basic lead carbonate (2PbCO₃Pb(OH)₂, also known as silver white), zinc oxide (ZnO, also known as zinc white), titanium oxide (TiO₂, also known as titanium white), and strontium titanate (SrTiO₃, also known as titan strontium white).

Here, titanium oxide has, compared with other white pigments, a low specific gravity, a high refractive index, and is chemically and physically stable, and therefore has high hiding power and coloring power as a pigment and, furthermore, has excellent durability toward acids, alkalis, and other environments. It is therefore preferable to use titanium oxide as the white pigment. It is of course possible to use another white pigment (which can be any white pigment, in addition to the white pigments cited above) as necessary.

For dispersion of the pigment, for example, a dispersing machine such as a ball mill, a sand mill, an attritor, a roll mill, a jet mill, a homogenizer, a paint shaker, a kneader, an agitator, a henschel mixer, a colloidal mill, an ultrasonic homogenizer, a pearl mill, or a wet type jet mill may be used.

When carrying out dispersion of the pigment, a dispersant may be added.

Examples of the dispersant include hydroxyl group-containing carboxylic acid esters, salts of a long-chain polyaminoamide and a high molecular weight acid ester, high molecular weight polycarboxylic acid salts, high molecular weight unsaturated acid esters, high molecular weight copolymers, modified polyacrylates, aliphatic polycarboxylic acids, naphthalenesulfonic acid formaldehyde condensates, polyoxyethylene alkylphosphate esters, and pigment derivatives. It is also preferable to use a commercial polymeric dispersant such as the Solsperse series manufactured by Zeneca.

Furthermore, as a dispersion adjuvant, it is also possible to use a synergist, depending on the various types of pigment. The dispersant and dispersion adjuvant are preferably used at 1 to 50 parts by weight relative to 100 parts by weight of the pigment.

In the ink composition, as a dispersing medium for various components such as the pigment, a solvent may be added, or the vinyl ether compound, the oxirane compound, or the oxetane compound, which is a low molecular weight compound, may be used as a dispersing medium without using a solvent, and since the ink composition of the present invention is a radiation curing type ink, and after the ink is applied on top of a recording medium it is cured, it is preferable not to use a solvent. This is because, if a solvent remains in the cured ink image, the solvent resistance is degraded and the VOC (Volatile Organic Compound) problem of the residual solvent occurs. From this viewpoint, it is preferable to use as a dispersing medium the vinyl ether compound, the oxirane compound, or the oxetane compound and, in particular, it is preferable to select a cationically polymerizable monomer having the lowest viscosity in terms of improvement of dispersion suitability and handling properties of the ink composition.

It is preferable for the average particle size of the pigment to be in the range of 0.02 to 4 μm, more preferably 0.02 to 2 μm, and yet more preferably, 0.02 to 1.0 μm.

In order to make the average particle size of the pigment particles be in the above-mentioned range, the pigment, the dispersant, and the dispersing medium are selected, and dispersion conditions and filtration conditions are set. By such control of particle size, clogging of a head nozzle can be suppressed, and the storage stability of ink, the ink transparency, and the curing sensitivity can be maintained.

### Dye

The dye that can be used in the present invention is preferably oil-soluble. Specifically, this means that the solubility in water at 25° C. (the weight of a dye that can be dissolved in 100 g of water) is equal to or less than 1 g, preferably equal to or less than 0.5 g, and more preferably equal to or less than 0.1 g. Therefore, the so-called oil-soluble dye, which is insoluble in water, is preferably used.

The dye that can be used in the present invention may preferably be formed by incorporating an oil-solubilizing group into a dye core described below in order to dissolve a necessary amount thereof in an ink composition.

Examples of the oil-solubilizing group include a long-chain or branched alkyl group, a long-chain or branched alkoxy group, a long-chain or branched alkylthio group, a long-chain or branched alkylsulfonyl group, a long-chain or branched acyloxy group, a long-chain or branched alkoxycarbonyl group, a long-chain or branched acyl group, a long-chain or branched acylamino group, a long-chain or branched alkylsulfonylamino group, a long-chain or branched alkylaminosulfonyl group, and an aryl group, aryloxy group, aryloxycarbonyl group, arylcarbonyloxy group, arylaminocarbonyl group, arylaminosulfonyl group, or arylsulfonylamino group containing the long-chain or branched substituent above.

Furthermore, a dye may be obtained by converting, using a long-chain branched alcohol, amine, phenol, or aniline derivative, a carboxylic acid or sulfonic acid of a water-soluble dye into an alkoxycarbonyl group, aryloxycarbonyl group, alkylaminosulfonyl group, or arylaminosulfonyl group, which are oil-solubilizing groups.

The above-mentioned oil-soluble dye preferably has a melting point of equal to or less than 200° C., more preferably a melting point of equal to or less than 150° C., and yet more preferably a melting point of equal to or less than 100° C. By using an oil-soluble dye having a low melting point, dye crystallization in the ink composition can be suppressed, and the storage stability of the ink composition is improved.

Furthermore, in order to improve discoloration resistance, in particular, the resistance to an oxidizing material such as ozone, and improve curing properties, it is desirable that the oxidation potential is high. Because of this, as the oil-soluble dye that can be used in the present invention, it is preferable to use those having an oxidation potential of equal to or greater than 1.0 V (vs SCE). The higher the oxidation potential the more preferable it is; those having an oxidation potential of equal to or greater than 1.1 V (vs SCE) are yet more preferable, and those having an oxidation potential of equal to or greater than 1.15V (vs SCE) or greater are particularly preferable.

As a yellow dye, a compound having a structure represented by Formula (Y-I) described in JP-A-2004-250483 is preferable.

Dyes represented by Formulae (Y-II) to (Y-IV) described in paragraph No. (0034) of JP-A-2004-250483 are particularly preferable, and specific examples thereof include compounds described in paragraph Nos. (0060) to (0071) of JP-A-2004-250483. The oil-soluble dye represented by Formula (Y-I) described in this publication may be used not only for a yellow ink but also for any color ink, including a black ink and a red ink.

As a magenta dye, a compound having a structure represented by Formulae (3) and (4) described in JP-A-2002-114930 is preferable, and specific examples thereof include compounds described in paragraph Nos. (0054) to (0073) of JP-A-2002-114930.

Particularly preferred dyes are azo dyes represented by Formulae (M-1) to (M-2) described in paragraph Nos. (0084) to (0122) of JP-A-2002-121414, and specific examples thereof include compounds described in paragraph Nos. (0123) to (0132) of JP-A-2002-121414. The oil-soluble dyes represented by Formulae (3), (4), and (M-1) to (M-2) described in this publication may be used not only for a magenta ink but also for any color ink, including a black ink and a red ink.

Preferred examples of a cyan dye include dyes represented by Formulae (I) to (IV) described in JP-A-2001-181547 and dyes represented by Formulae (IV-1) to (IV-4) described in paragraph Nos. (0063) to (0078) of JP-A-2002-121414, and specific examples thereof include compounds described in paragraph Nos. (0052) to (0066) of JP-A-2001-181547, and paragraph Nos. (0079) to (0081) of JP-A-2002-121414.

Particularly preferred dyes are phthalocyanine dyes represented by Formulae (C-I) and (C-II) described in paragraph Nos. (0133) to (0196) of JP-A-2002-121414, and a phthalocyanine dye represented by Formula (C-II) is more preferable. Specific examples thereof include compounds described in paragraph Nos. (0198) to (0201) of JP-A-2002-121414. The oil-soluble dyes represented by the above-mentioned Formulae (I) to (IV), (IV-1) to (IV-4), (C-I), and (C-II) may be used not only for a cyan ink but also for any color ink, including a black ink and a green ink.

The colorant is preferably added at 1 to 20 wt % relative to the total weight of the ink composition, and more preferably at 2 to 10 wt %.

### Other Components

The ink composition that can be used in the present invention may comprise various types of additives according to an intended application in addition to the above-mentioned essential components. These optional components are explained.

### UV Absorber

In the present invention, a UV absorber may be used from the viewpoint of improving the weather resistance of an image obtained and preventing discoloration.

The UV absorbers include benzotriazole compounds described in JP-A-58-185677, JP-A-61-190537, JP-A-2-782, JP-A-5-197075 and JP-A-9-34057; benzophenone compounds described in JP-A-46-2784, JP-A-5-194483 and U.S. Pat. No. 3,214,463; cinnamic acid compounds described in JP-B-48-30492, JP-B-56-21141 and JP-A-10-88106; triazine compounds described in JP-A-4-298503, JP-A-8-53427, JP-A-8-239368, JP-A-10-182621 and JP-W-8-501291 (the term “JP-W” as used herein means an unexamined published international patent application); compounds described in Research Disclosure No. 24239; and compounds represented by stilbene and benzoxazole compounds, which absorb UV rays to emit fluorescence, the so-called fluorescent brightening agents.

The amount thereof added is appropriately selected according to the intended application, and it is generally on the order of 0.5 to 15 wt % on the basis of the solids content in the ink composition.

### Antioxidant

In order to improve the stability of the ink composition, an antioxidant may be added. Examples of the antioxidant include those described in Laid-open European Patent Nos. 223739, 309401, 309402, 310551, 310552, and 459416, Laid-open German Patent No. 3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount thereof added is appropriately selected according to the intended application, and it is preferably on the order of 0.1 to 8 wt % on the basis of the solids content in the ink composition.

### Antifading Agent

The ink composition in the present invention may employ various organic and metal complex antifading agents.

The organic antifading agents include hydroquinones, alkoxyphenols, dialkoxyphenols, phenols, anilines, amines, indanes, chromans, alkoxyanilines, and heterocycles.

The metal complex antifading agents include nickel complexes and zinc complexes. More specifically, there can be used compounds described in patents cited in Research Disclosure, No. 17643, Items VII-I to J, ibid., No. 15162, ibid., No. 18716, page 650, left-hand column, ibid., No. 36544, page 527, ibid., No. 307105, page 872, and ibid., No. 15162, and compounds contained in general formulae and compound examples of typical compounds described in JP-A-62-215272, pages 127 to 137.

The amount thereof added is appropriately selected according to the intended application, and it is preferably on the order of 0.1 to 8 wt % on the basis of the solids content in the ink composition.

### Conductive Salt

The ink composition of the present invention may contain, for the purpose of controlling discharge properties, a conductive salt such as potassium thiocyanate, lithium nitrate, ammonium thiocyanate, or dimethylamine hydrochloride.

### Solvent

A trace amount of organic solvent may be added to the ink composition in the present invention in order to improve the adhesion to a recording medium, but it is a preferable embodiment that no solvent is added.

Examples of the solvent include ketone-based solvents such as acetone, methyl ethyl ketone, and diethyl ketone, alcohol-based solvents such as methanol, ethanol, 2-propanol, 1-propanol, 1-butanol, and tert-butanol, chlorine-based solvents such as chloroform and methylene chloride, aromatic-based solvents such as benzene and toluene, ester-based solvents such as ethyl acetate, butyl acetate, and isopropyl acetate, ether-based solvents such as diethyl ether, tetrahydrofuran, and dioxane, and glycol ether-based solvents such as ethylene glycol monomethyl ether and ethylene glycol dimethyl ether.

In this case, it is effective if the amount thereof added is in a range that does not cause problems with the solvent resistance or the VOC, and the amount is preferably in the range of 0.1 to 5 wt % relative to the total amount of the ink composition, and more preferably 0.1 to 3 wt %.

### High Molecular Weight Compound

In the present invention, the ink composition may contain various types of high molecular weight compounds in order to adjust film physical properties. Examples of the high molecular weight compounds include acrylic polymers, polyvinylbutyral resins, polyurethane resins, polyamide resins, polyester resins, epoxy resins, phenol resins, polycarbonate resins, polyvinylformal resins, shellac, vinylic resins, acrylic resins, rubber-based resins, waxes, and other natural resins. They may be used in a combination of two or more types. Among these, a vinylic copolymer obtained by copolymerization of an acrylic monomer is preferable. Furthermore, as a copolymer component of the high molecular weight compound, a copolymer containing as a structural unit a ‘carboxyl group-containing monomer’, an ‘alkyl methacrylate ester’, or an ‘alkyl acrylate ester’ may preferably be used.

### Surfactant

The ink composition in the present invention may contain a surfactant.

As the surfactant, those described in JP-A-62-173463 and JP-A-62-183457 can be cited. Examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl allyl ethers, acetylene glycols, and polyoxyethylene/polyoxypropylene block copolymers, and cationic surfactants such as alkylamine salts and quaternary ammonium salts. Instead of the surfactant, an organofluoro compound may be used. The organofluoro compound is preferably hydrophobic. Examples of the organofluoro compound include fluorine-based surfactants, oil-like fluorine-based compounds (e.g. a fluorine oil), and solid fluorine compounds resin (e.g. tetrafluoroethylene resin), and those described in JP-B-57-9053 (8th to 17th columns) and JP-A-62-135826.

In addition to the above, the composition may contain as necessary, for example, a leveling additive, a matting agent, a wax for adjusting film physical properties, or a tackifier in order to improve the adhesion to a recording medium such as polyolefin or PET, the tackifier not inhibiting polymerization.

Specific examples of the tackifier include high molecular weight tacky polymers described on pp. 5 and 6 of JP-A-2001-49200 (e.g. a copolymer formed from an ester of (meth)acrylic acid and an alcohol having an alkyl group with 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated bond.

The surface tension of the ink composition that can be used in the present invention is preferably 20 to 40 mN/m, and yet more preferably 25 to 35 mN/m. When recording is carried out on various types of recording medium such as polyolefin, PET, coated paper, and uncoated paper, from the viewpoint of spread and penetration, it is preferably at least 20 mN/m, and from the viewpoint of wettability it is preferably not more than 40 mN/m.

The ink composition prepared in this way is suitably used as an inkjet recording ink.

When it is used as an inkjet recording ink, recording is carried out by ejecting the ink composition onto a recording medium by means of an inkjet printer and then irradiating the ejected ink composition with radiation.

Since a printed material obtained using this ink has an image area cured by exposure to radiation such as UV rays and the strength of the image area is excellent, it can be used in various types of application other than formation of an image using the ink, such as, for example, formation of an ink receiving layer (image area) of a lithographic printing plate.

### Sensitizing Dye

In the present invention, the ink composition may contain a sensitizing dye in order to promote decomposition of the above-mentioned polymerization initiator. Preferred examples of the sensitizing dye include those in the categories of compounds below and have an adsorption wavelength in the region of 350 nm to 450 nm.

Examples thereof include polynuclear aromatic compounds (e.g. pyrene, perylene, triphenylene), xanthenes (e.g. fluorescein, eosin, erythrosine, rhodamine B, rose bengal), cyanines (e.g. thiacarbocyanine, oxacarbocyanine), merocyanines (e.g. merocyanine, carbomerocyanine), thiazines (e.g. thionine, methylene blue, toluidine blue), acridines (e.g. acridine orange, chloroflavine, acriflavine), anthraquinones (e.g. anthraquinone), squaryliums (e.g. squarylium), and coumarins (e.g. 7-diethylamino-4-methylcoumarin).

The amount thereof added is appropriately selected according to the intended application, and it is generally used at 0.01 to 1 mol % relative to the cationic photopolymerization initiator, and preferably 0.1 to 0.5 mol %.

### Supersensitizer

The ink composition in the present invention preferably comprises a Supersensitizer (cosensitizer).

In the present invention, the supersensitizer has the function of further improving the sensitivity of the sensitizing dye to UV rays or the function of suppressing inhibition by oxygen of polymerization of a polymerizable compound, etc.

Examples of such a supersensitizer include amines such as compounds described in M. R. Sander et al., ‘Journal of Polymer Society’, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure No. 33825, and specific examples thereof include triethanolamine, ethyl p-dimethylaminobenzoate, p-formyldimethylaniline, and p-methylthiodimethylaniline.

Other examples of the supersensitizer include thiols and sulfides such as thiol compounds described in JP-A-53-702, JP-B-55-500806, and JP-A-5-142772, and disulfide compounds of JP-A-56-75643, and specific examples thereof include 2-mercaptobenzothiazole, 2-mercaptobenzoxazole, 2-mercaptobenzimidazole, 2-mercapto-4(3H)-quinazoline, and β-mercaptonaphthalene.

Yet other examples of the supersensitizer include amino acid compounds (e.g. N-phenylglycine, etc.), organometallic compounds described in JP-B-48-42965 (e.g. tributyltin acetate, etc.), hydrogen-donating compounds described in JP-B-55-34414, sulfur compounds described in JP-A-6-308727 (e.g. trithiane, etc.), phosphorus compounds described in JP-A-6-250387 (diethylphosphite, etc.), and Si—H or Ge—H compounds described in JP-A-8-54735.

It is preferable to add the polymerization inhibitor from the viewpoint of enhancing the storage stability.

When the ink composition is used as an inkjet recording ink composition, it is preferably heated in the range of 25° C. to 80° C. to thus make it less viscous and then discharged, and in order to prevent clogging of a head due to thermal polymerization it is preferable to add a polymerization inhibitor.

The polymerization inhibitor is preferably added at 200 to 20,000 ppm relative to the total amount of the ink composition of the present invention.

Examples of the polymerization inhibitor include hydroquinone, benzoquinone, p-methoxyphenol, TEMPO, TEMPOL, and Al cupferron.

### Other Component

In addition to the above, the ink composition invention may contain a known compound as necessary. Examples thereof include a surfactant a leveling additive, a matting agent and, for adjusting film physical properties, a polyester resin, polyurethane resin, vinyl resin, acrylic resin, rubber resin, or wax, which may be appropriately selected and added. Furthermore, in order to improve the adhesion to a recording medium such as a polyolefin or PET, a tackifier that does not inhibit polymerization is preferably added. Specific examples of the tackifier include high molecular weight tacky polymers described on pp. 5 and 6 of JP-A-2001-49200 (e.g. a copolymer formed from an ester of (meth)acrylic acid and an alcohol having an alkyl group with 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated bond.

Furthermore, as means for preventing the sensitivity from being degraded by a light blocking effect of the colorant contained in the ink composition, a combination of a cationically polymerizable compound and a cationic polymerization initiator having long initiating life, or a radical/cationic hybrid type curing ink composition is a preferable embodiment.

Furthermore, the ink composition that can be used in the present invention may employ a known cationic polymerizable compound other than the vinyl ether compounds, the oxirane compounds, and the oxetane compounds.

In accordance with the present invention, there can be provided an inkjet recording method and inkjet recording system that can form high quality images over a long period of time using a small-size, inexpensive UV irradiation device and can form printed materials having high film strength irrespective of environmental temperature, and a printed material obtained by using the inkjet recording method and/or inkjet recording system.

### EXAMPLES

The present invention is explained in detail below by reference to examples and comparative examples. But the present invention should not be construed as being limited thereto.

‘Parts’ described below means ‘parts by weight’ unless otherwise specified.

Materials used in the present invention are as listed below.

### Pigment

Copper phthalocyanine (Toyo Ink Mfg. Co., Ltd.)
Quinacridone-based red pigment (CINQUASIA MAGENTA RT-355-D, Ciba-Geigy Corp.)
Benzimidazolone-based yellow pigment (Hostaperm Yellow H3G, Hoechst)

### Oxirane Compound

CELLOXIDE 3000 (CEL3000, DAICEL CHEMICAL INDUSTRIES, LTD.)

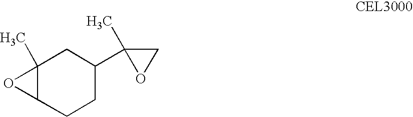

UVR-6105 (Union Carbide Corporation)

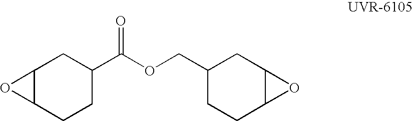

### Oxetane Compound

OXT-221 (compound below, TOAGOSEI CO, LTD.)

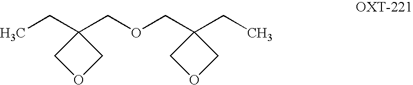

OXT-212 (compound below, TOAGOSEI CO, LTD.)

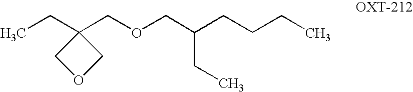

### Vinyl Ether Compound

DVE-3 (triethylene glycol divinyl ether, RAPI-CURE DVE-3, ISP Europe)
VE-A (compound below)
VE-B (compound below)
VE-C (compound below)
VE-D (compound below)
VE-E (compound below)

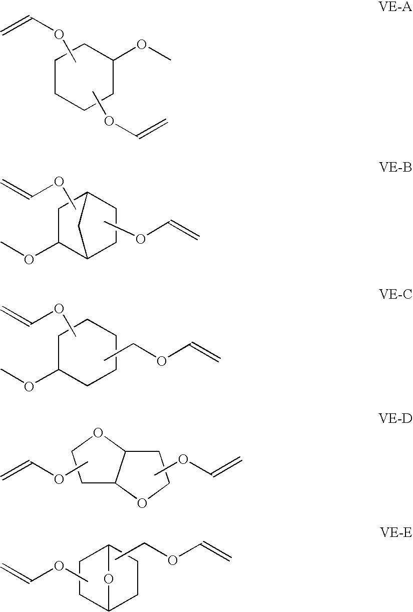

### Pigment-Dispersing Agent

solsperse32000 (dispersant, Lubrizol Corporation)

### Cationic Photopolvmerization Initiator

SP-150 (Triphenylsulfonium salt, ADEKA CORPORATION)

### Preparation of Ink Compositions 1 to 30

By mixing materials at the proportions shown in Tables 1 to 4 using a stirrer, ink compositions 1 to 30 were obtained. The numerals in the tables denote parts by weight.

TABLE 1

| | | Ink composition No. | | | | | | | | |
|---|---|---|---|---|---|---|---|---|---|---|
| | | 1 | 2 | 3 | 4 | 5 | 6 | 7 | 8 | 9 |
| Pigment | Copper | 5 | 5 | — | — | — | — | 5 | 5 | — |
| | phthalocyanine | | | | | | | | | |
| | Quinacridone- | — | — | 5 | 5 | — | — | — | — | 5 |
| | based red pigment | | | | | | | | | |
| | Benzimidazolone- | — | — | — | — | 5 | 5 | — | — | — |
| | based yellow | | | | | | | | | |
| | pigment | | | | | | | | | |
| Oxirane | Celloxide 3000 | 60 | 52 | 17 | 60 | 52 | 17 | 60 | 52 | 17 |
| compound | | | | | | | | | | |
| Oxetane | OXT-221 | 10 | 5 | 5 | 10 | 5 | 5 | 10 | 5 | 5 |
| compound | OXT-212 | 10 | — | — | 10 | — | — | 10 | — | — |
| Vinyl | DVE-3 | 7 | 30 | 65 | — | — | — | — | — | — |
| ether | VE-A | — | — | — | 7 | 30 | 65 | — | — | — |
| compound | VE-B | — | — | — | — | — | — | 7 | 30 | 65 |
| Pigment- | Solsperse 32000 | 3 | 3 | 3 | 3 | 3 | 3 | 3 | 3 | 3 |
| dispersing | | | | | | | | | | |
| agent | | | | | | | | | | |
| Initiator | SP-150 | 5 | 5 | 5 | 5 | 5 | 5 | 5 | 5 | 5 |

TABLE 2

| | | Ink composition No. | | | | | | | | |
|---|---|---|---|---|---|---|---|---|---|---|
| | | 10 | 11 | 12 | 13 | 14 | 15 | 16 | 17 | 18 |
| Pigment | Copper | — | — | — | 5 | 5 | — | — | — | — |
| | phthalocyanine | | | | | | | | | |
| | Quinacridone- | 5 | — | — | — | — | 5 | 5 | — | — |
| | based red pigment | | | | | | | | | |
| | Benzimidazolone- | — | 5 | 5 | — | — | — | — | 5 | 5 |
| | based yellow | | | | | | | | | |
| | pigment | | | | | | | | | |
| Oxirane | Celloxide 3000 | 60 | 52 | 17 | 60 | 52 | 17 | 60 | 52 | 17 |
| compound | | | | | | | | | | |
| Oxetane | OXT-221 | 10 | 5 | 5 | 10 | 5 | 5 | 10 | 5 | 5 |
| compound | OXT-212 | 10 | — | — | 10 | — | — | 10 | — | — |
| Vinyl | VE-C | 7 | 30 | 65 | — | — | — | — | — | — |
| ether | VE-D | — | — | — | 7 | 30 | 65 | — | — | — |
| compound | VE-E | — | — | — | — | — | — | 7 | 30 | 65 |
| Pigment- | Solsperse 32000 | 3 | 3 | 3 | 3 | 3 | 3 | 3 | 3 | 3 |
| dispersing | | | | | | | | | | |
| agent | | | | | | | | | | |
| Initiator | SP-150 | 5 | 5 | 5 | 5 | 5 | 5 | 5 | 5 | 5 |

TABLE 3

| | | Ink composition No. | | | | | |
|---|---|---|---|---|---|---|---|
| | | 19 | 20 | 21 | 22 | 23 | 24 |
| Pigment | Copper | 5 | 5 | — | — | — | — |
| | phthalocyanine | | | | | | |
| | Quinacridone- | — | — | 5 | 5 | — | — |
| | based red pigment | | | | | | |
| | Benzimidazolone- | — | — | — | — | 5 | 5 |
| | based yellow | | | | | | |
| | pigment | | | | | | |
| Oxirane compound | Celloxide 3000 | 2 | 2 | — | — | — | 2 |
| | UVR-6105 | — | — | — | — | 2 | — |
| Oxetane compound | OXT-221 | — | — | 2 | 2 | — | — |
| | OXT-212 | — | — | — | — | — | — |
| Vinyl ether compound | DVE-3 | 85 | — | — | — | — | — |
| | VE-A | — | 85 | — | — | — | — |
| | VE-B | — | — | 85 | — | — | — |
| | VE-C | — | — | — | 85 | — | — |
| | VE-D | — | — | — | — | 85 | — |
| | VE-E | — | — | — | — | — | 85 |
| Pigment-dispersing agent | Solsperse 32000 | 3 | 3 | 3 | 3 | 3 | 3 |
| Initiator | SP-150 | 5 | 5 | 5 | 5 | 5 | 5 |

TABLE 4

| | | Ink composition No. | | | | | |
|---|---|---|---|---|---|---|---|
| | | 25 | 26 | 27 | 28 | 29 | 30 |
| Pigment | Copper | 5 | 5 | — | — | — | — |
| | phthalocyanine | | | | | | |
| | Quinacridone- | — | — | 5 | 5 | — | — |
| | based red pigment | | | | | | |
| | Benzimidazolone- | — | — | — | — | 5 | 5 |
| | based yellow | | | | | | |
| | pigment | | | | | | |
| Oxirane compound | Celloxide 3000 | 27 | 27 | 27 | 27 | 27 | 27 |
| Oxetane compound | OXT-221 | 60 | 60 | 60 | 60 | 60 | 60 |
| Pigment-dispersing agent | Solsperse 32000 | 3 | 3 | 3 | 3 | 3 | 3 |
| Initiator | SP-150 | 5 | 5 | 5 | 5 | 5 | 5 |

### Inkjet Image Recording Method

Color printed images 1 to 30 having an average film thickness of 12 μm were prepared by an inkjet recording method using ink compositions 1 to 30.

With regard to the inkjet recording method, recording was carried out on a recording medium using an inkjet recording system shown in FIG. 1. It should be noted that in the examples an undercoat layer was not provided.

The ink composition supply system comprised a main tank, a supply pipe, an ink composition supply tank immediately before an inkjet head, a filter, and a piezo type inkjet head, and a section from the ink composition supply tank to the inkjet head was thermally insulated and heated. Temperature sensors were provided on the ink composition supply tank and in the vicinity of the nozzle of the inkjet head, and the temperature was controlled so that the nozzle section was always at 45° C. ±2° C. The piezo type inkjet head was driven so as to discharge multisize dots of 8 to 30 pL at a resolution of 720×720 dpi. The exposure system, the main scanning speed, and the discharge frequency were adjusted so that, after landing, UV light was focused to give an exposure area illumination intensity of 1,630 mW/cm², and irradiation started 0.1 sec. after the ink composition landed on the recording medium. The cumulative amount of light applied to an image was adjusted so as to be 1,000 mJ/cm². With respect to UV irradiation means, as shown in FIG. 2 UV irradiation means comprising an aperture type hot cathode fluorescent tube having a getter in the interior thereof was used. Here, dpi referred to in the present invention denotes the number of dots per 2.54 cm. The recording medium employed a PET film (HK31-WF: transparent support, film thickness 120 μm, Higashiyama Film Co., Ltd.).

### Evaluation Methods

### Method for Measuring Curing Sensitivity

In accordance with the above-mentioned inkjet recording method, continuous printing was carried out for 1,000 hours, and solid printed images having an average film thickness of 12 μm for each color 100 hours and 1,000 hours after starting printing were subjected to evaluation by touch for the tackiness of the image using the following criteria.
Excellent: No tackiness at all on image.
Good: Image was slightly tacky, but when printed materials were superimposed, no ink was transferred to the back side, and there were no problems.
Fair: Image was somewhat tacky, and when printed materials were superimposed a small amount of ink was transferred to the back side, but there were no problems in practice.
Poor: Not hardened, to the extent that uncured ink composition was transferred to the hand, or when printed materials were superimposed, ink was transferred to the back side, and there were problems in practice.

### Discharge Stability

In accordance with the above-mentioned inkjet recording method, 10 sheets of A4 size PET film were subjected to a continuous image recording test, the inkjet recording system was left for 2 weeks, the image recording test was then carried out again, and the first image was visually evaluated using the following criteria.
Excellent: There were no defects in the image.
Good: There were slight defects in the image, but there were no problems in practice.
Poor: Image drop-outs were observed on the leading edge, which suggested initial discharge failure, or image defects due to nozzle clogging were observed.

Table 5 and Table 6 below give the evaluation results when ink compositions 1 to 30 were used and the UV irradiation means having an aperture type hot cathode fluorescent tube having a getter in its interior shown in FIG. 2 was used as UV irradiation means.

TABLE 5

| | Ink | | Sensitivity (curability) | |
|---|---|---|---|---|
| | composition | | After | After |
| Example | No. | Dischargeability | 100 hours | 1,000 hours |
| 1 | 1 | Excellent | Excellent | Excellent |
| 2 | 2 | Excellent | Excellent | Excellent |
| 3 | 3 | Excellent | Excellent | Excellent |
| 4 | 4 | Excellent | Excellent | Excellent |
| 5 | 5 | Excellent | Excellent | Excellent |
| 6 | 6 | Excellent | Excellent | Excellent |
| 7 | 7 | Excellent | Excellent | Excellent |
| 8 | 8 | Excellent | Excellent | Excellent |
| 9 | 9 | Excellent | Excellent | Excellent |
| 10 | 10 | Excellent | Excellent | Excellent |
| 11 | 11 | Excellent | Excellent | Excellent |
| 12 | 12 | Excellent | Excellent | Excellent |
| 13 | 13 | Excellent | Excellent | Excellent |
| 14 | 14 | Excellent | Excellent | Excellent |
| 15 | 15 | Excellent | Excellent | Excellent |
| 16 | 16 | Excellent | Excellent | Excellent |
| 17 | 17 | Excellent | Excellent | Excellent |
| 18 | 18 | Excellent | Excellent | Excellent |
| 19 | 19 | Excellent | Good | Good |
| 20 | 20 | Excellent | Good | Good |
| 21 | 21 | Excellent | Good | Good |
| 22 | 22 | Excellent | Good | Good |
| 23 | 23 | Excellent | Good | Good |
| 24 | 24 | Excellent | Good | Good |

TABLE 6

| | | | Sensitivity (curability) | |
|---|---|---|---|---|
| Comparative | Ink composition | Discharge | After | After |
| Example | No. | stability | 100 hours | 1,000 hours |
| 1 | 25 | Poor | Excellent | Excellent |
| 2 | 26 | Poor | Excellent | Excellent |
| 3 | 27 | Poor | Excellent | Excellent |
| 4 | 28 | Poor | Excellent | Excellent |
| 5 | 29 | Poor | Excellent | Excellent |
| 6 | 30 | Poor | Excellent | Excellent |

Table 7 below shows the evaluation results when ink compositions 1, 4, 7, 10, 13, and 16 were used, and UV irradiation means having an aperture type hot cathode fluorescent tube having no getter in its interior, UV irradiation means having a hot cathode fluorescent tube having a getter in its interior but having no aperture, or UV irradiation means having a hot cathode fluorescent tube having no getter in its interior and no aperture was used as UV irradiation means.

TABLE 7

| | | | | Sensitivity | |
|---|---|---|---|---|---|
| | | | | (curability) | |
| | | | | | After |
| Comparative | Ink composition | Exposure device | | After | 1,000 |
| Example | No. | Aperture | Getter | 100 hours | hours |
| 7 | 1 | No | No | Fair | Poor |
| 8 | | Yes | No | Good | Poor |
| 9 | | No | Yes | Fair | Poor |
| 10 | 4 | No | No | Fair | Poor |
| 11 | | Yes | No | Good | Poor |
| 12 | | No | Yes | Fair | Poor |
| 13 | 7 | No | No | Fair | Poor |
| 14 | | Yes | No | Good | Poor |
| 15 | | No | Yes | Fair | Poor |
| 16 | 10 | No | No | Fair | Poor |
| 17 | | Yes | No | Good | Poor |
| 18 | | No | Yes | Fair | Poor |
| 19 | 13 | No | No | Fair | Poor |
| 20 | | Yes | No | Good | Poor |
| 21 | | No | Yes | Fair | Poor |
| 22 | 16 | No | No | Fair | Poor |
| 23 | | Yes | No | Good | Poor |
| 24 | | No | Yes | Fair | Poor |

What is claimed is:

1. An inkjet recording method comprising:
a step of discharging onto a recording medium an ink composition comprising a vinyl ether compound, an oxirane compound and/or oxetane compound, a cationic photopolymerization initiator, and a colorant; and
a step of curing the discharged ink composition by irradiation with UV rays by UV irradiation means comprising an aperture type hot cathode fluorescent tube having a getter in the interior thereof.

2. The inkjet recording method according to claim 1, wherein the vinyl ether compound in the ink composition has a content of 1 to 84 wt %.

3. The inkjet recording method according to claim 1, wherein the ratio by weight of the vinyl ether compound to the total amount of the oxirane compound and oxetane compound in the ink composition is vinyl ether compound:oxirane compound and oxetane compound=1:99 to 90:10.

4. The inkjet recording method according to claim 1, wherein the ink composition has a viscosity at 25° C. of 5 to 50 mPa·s.

5. The inkjet recording method according to claim 1, wherein the ink composition comprises an oxirane compound and an oxetane compound.

6. The inkjet recording method according to claim 1, wherein the vinyl ether compound is a compound represented by Formula (1)
R¹³—R¹⁴—(R¹³)p (1)
(in Formula (1), R¹³ is selected from a vinyl ether group, a vinyl ether skeleton-containing group, an alkoxy group, a hydroxy group-substituted group, and a hydroxy group, at least one thereof being a vinyl ether group or a vinyl ether skeleton-containing group, R¹⁴ is a (p+1)-valent group having a substituted or unsubstituted cyclic skeleton, and p is a positive integer including 0).

7. The inkjet recording method according to claim 1, wherein the vinyl ether compound is at least one compound selected from the group consisting of VE-A to VE-E.

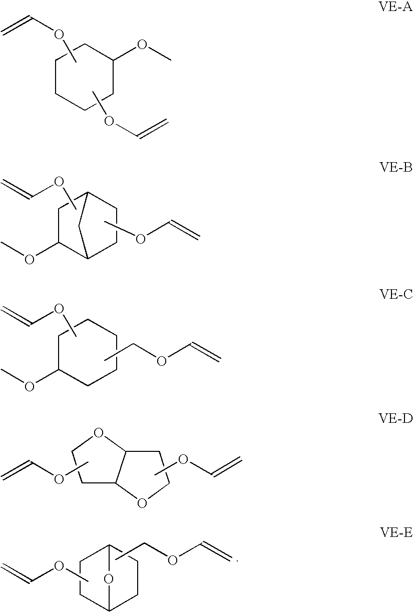

8. The inkjet recording method according to claim 1, wherein the hot cathode fluorescent tube further comprises a cooling mechanism.

9. A printed material obtained by the inkjet recording method according to claim 1.

10. An inkjet recording system comprising:
recording medium transport means;
an inkjet head for discharging an ink composition comprising a vinyl ether compound, an oxirane compound and/or oxetane compound, a cationic photopolymerization initiator, and a colorant to thus form an image on a recording medium; and
UV irradiation means for curing the ink composition discharged onto the recording medium by irradiation with UV rays;
the UV irradiation means comprising as a UV light source an aperture type hot cathode fluorescent tube having a getter in the interior thereof.

11. The inkjet recording system according to claim 10, wherein the vinyl ether compound in the ink composition has a content of 1 to 84 wt %.

12. The inkjet recording system according to claim 10, wherein the ratio by weight of the vinyl ether compound to the total amount of the oxirane compound and oxetane compound in the ink composition is vinyl ether compound:oxirane compound and oxetane compound=1:99 to 90:10.

13. The inkjet recording system according to claim 10, wherein the ink composition has a viscosity at 25° C. of 5 to 50 mPa·s.

14. The inkjet recording system according to claim 10, wherein the ink composition comprises an oxirane compound and an oxetane compound.

15. The inkjet recording system according to claim 10, wherein the vinyl ether compound is a compound represented by Formula (1)
R¹³—R¹⁴—(R¹³)p (1)
(in Formula (1), R¹³ is selected from a vinyl ether group, a vinyl ether skeleton-containing group, an alkoxy group, a hydroxy group-substituted group, and a hydroxy group, at least one thereof being a vinyl ether group or a vinyl ether skeleton-containing group, R is a (p+1)-valent group having a substituted or unsubstituted cyclic skeleton, and p is a positive integer including 0).

16. The inkjet recording system according to claim 10, wherein the vinyl ether compound is at least one compound selected from the group consisting of VE-A to VE-E.

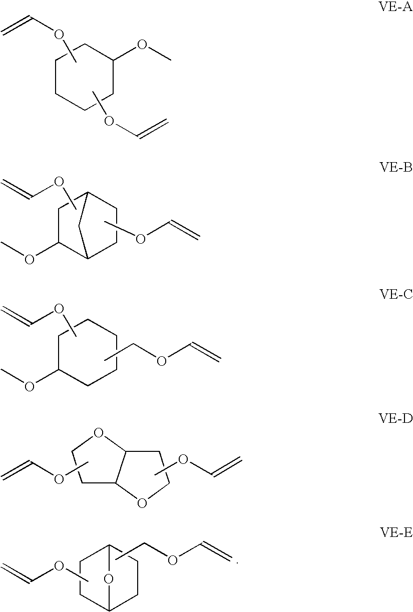

17. The inkjet recording system according to claim 10, wherein the hot cathode fluorescent tube further comprises a cooling mechanism.

18. A printed material obtained using the inkjet recording system according to claim 10.
